(19) United States
(12) Patent Application Publication
(10) Pub. No.: US 2025/0313658 A1
(43) Pub. Date: Oct. 9, 2025

(54) COPOLYMERS OF GLYCOLALDEHYDE DIMERS AND METHOD OF MAKING SAME

(71) Applicant: Sustainable Chemicals, Inc., Golden, CO (US)

(72) Inventors: Silvia De Vito LUEBBEN, Golden, CO (US); Yaman Efe PEKSENAR, Golden, CO (US)

(21) Appl. No.: 19/243,465

(22) Filed: Jun. 19, 2025

Related U.S. Application Data
(63) Continuation-in-part of application No. PCT/US2023/084958, filed on Dec. 19, 2023.
(63) Continuation-in-part of application No. 19/172,571, filed on Apr. 7, 2025.
(60) Provisional application No. 63/433,570, filed on Dec. 19, 2022.
(60) Provisional application No. 63/500,659, filed on May 8, 2023.
(60) Provisional application No. 63/784,883, filed on Apr. 7, 2025.
(60) Provisional application No. 63/784,585, filed on Apr. 7, 2025.

(51) Int. Cl. C08G 16/02; C08G 18/32; C08G 63/672; C08G 64/02

(52) U.S. Cl. CPC C08G 16/0256; C08G 18/3218; C08G 63/672; C08G 64/0208

(57) ABSTRACT

Polymer and copolymers and compositions containing one or more of such polymers and copolymers. Polymers and copolymers comprise two or more structurally different glycolaldehyde dimers as monomer units. Exemplary glycolaldehyde dimers are 2,5-dihydroxy-1,4-dioxane; (1,2-hydroxyethoxy) acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde). Copolymers containing one or more glycolaldehyde dimers and a second monomer that is not a glycolaldehyde dimer are also provided. Copolymers exhibit improved optical and mechanical properties.

### CROSS-REFERENCE TO RELATED APPLICATIONS

This application claims the priority benefit of U.S. provisional application 63/433,570, filed Dec. 19, 2022, U.S. provisional application 63/500,659, filed May 8, 2023, U.S. provisional application 63/784,883, filed Apr. 7, 2025 and U.S. provisional application 63/784,585, filed Apr. 7, 2025 and is a continuation-in-part of International application PCT/US23/84958, filed Dec. 19, 2023 and U.S. application Ser. No. 19/172,571, filed Apr. 7, 2025. Each of these applications is incorporated by reference herein in its entirety.

### STATEMENT REGARDING FEDERALLY SPONSORED RESEARCH OR DEVELOPMENT

This invention was made with government support awarded under contracts No. 2024-33610-43307 and 2024-33530-41906 by the U.S. Department of Agriculture. The government has certain rights in this invention.

### BACKGROUND

This invention relates to polymers, particularly copolymers, that comprise one or more dimer of glycolaldehyde as one of the comonomers. More specifically, the invention relates to polymers and copolymers that comprise two or more dimers of glycolaldehyde as comonomers. The invention also relates to resins, coatings, foams, adhesives, interpenetrating networks and elastomers comprising such polymers and copolymers or made from such polymers and copolymers. The invention also relates to methods for making such polymers and copolymers and related materials.

There is a significant need to replace or supplement polymeric materials currently generated from petroleum materials with polymers or portions thereof generated from renewable resources. Renewable polymers which exhibit commercially useful properties are of particular interest. The present invention relates to copolymeric materials generated at least in part from glycolaldehyde (also called hydroxyacetaldehyde) dimers which can be generated in high yield at relatively low cost from renewable resources (e.g., plant-based biomass).

U.S. Pat. No. 5,397,582 reports a pyrolysis process employing sugar and or starch feedstock to produce a water-soluble pyrolysis liquid which contains glycolaldehyde.

U.S. Pat. No. 7,094,932 reports a process for making glycolaldehyde by hydrous thermolysis of aqueous sugar (e.g., glucose) solutions.

U.S. published patent application 20200392061 reports a large scale, energy efficient process for production of oxygenates from sugar feedstock. The process involves thermolytic fragmentation of a sugar solution in a fragmentation reactor in which the sugar solution is carried in a fluidized bed with heat carrying particles. Thermolytic fragmentation of a glucose solution is reported to provide a high yield of glycolaldehyde.

U.S. Pat. No. 9,040,635 reports polymers made from renewable resources based on polymerization of α-hydroxycarbonyl compounds (α-hydroxyaldehydes and α-hydroxyketones) and particularly glycolaldehyde. Polymers and copolymers are made by a method comprising a step of reacting the cyclic dimer of glycolaldehyde (2,5-dihydroxy-1,4-dioxane) with trimethylsilyltrifluoromethane sulfonate. More generally, a method is reported that comprises dehydrating a cyclic dimer of one or more α-hydroxycarbonyl compounds. End capped polymers in which prepared polymers are reacted with an end capping reagent are also reported.

The present invention provides copolymers prepared at least in part from renewable resources that greatly expand the physical and optical properties of previously available polymeric material from renewable resources. Polymers of this invention, for example, have improved optical clarity, and improved flexibility in thin film form.

### SUMMARY OF THE INVENTION

In one aspect, this invention provides a copolymer composition that comprises, consists essentially of, or consists of two or more structurally different glycolaldehyde dimers (as monomer units in the copolymer). In embodiments, the dimers are selected from the group consisting of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde (see Scheme 1 for unsubstituted dimers). Each of the glycolaldehyde dimers in the copolymers herein can be optionally substituted. A given glycolaldehyde dimer may form structurally different repeating units on polymerization. Copolymers containing two or more glycolaldehyde dimers have improved properties compared to homopolymers that contain repeating units that are substantially derived from the six-member ring form of the glycolaldehyde dimer (i.e., monomer 2,5-dihydroxy-1,4-dioxane). The copolymers herein comprising, consisting essentially of or consisting of two or more different optionally substituted glycolaldehyde dimers exhibit improved optical clarity and thin film flexibility compared to homopolymers comprising, consisting essentially of or consisting of only or substantially only 2,5-dihydroxy-1,4-dioxane repeating units. In embodiments, the copolymers comprising, consisting essentially of or consisting of two or more structurally different optionally substituted glycolaldehyde dimers have from 0.1% to 25% by weight of monomers other than optionally substituted 2,5-dihydroxy-1,4-dioxane. In embodiments, the copolymers comprising, consisting essentially of or consisting of two or more structurally different optionally substituted glycolaldehyde dimers have from 0.5%-10% by weight of monomers other than optionally substituted 2,5-dihydroxy-1,4-dioxane. In other embodiments, the copolymers comprising, consisting essentially of or consisting of two or more structurally different optionally substituted glycolaldehyde dimers have from 1%-5% by weight of monomers other than optionally substituted 2,5-dihydroxy-1,4-dioxane. The term “substantially all” with respect to repeating units and monomers refers to greater than 99.9% by weight.

In embodiments, the copolymer of two or more optionally substituted glycolaldehyde dimers is of Structure 1:

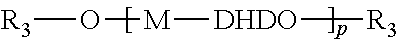

which in more detail can be written as:

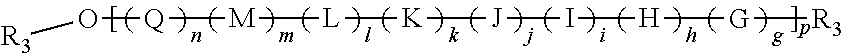

where:

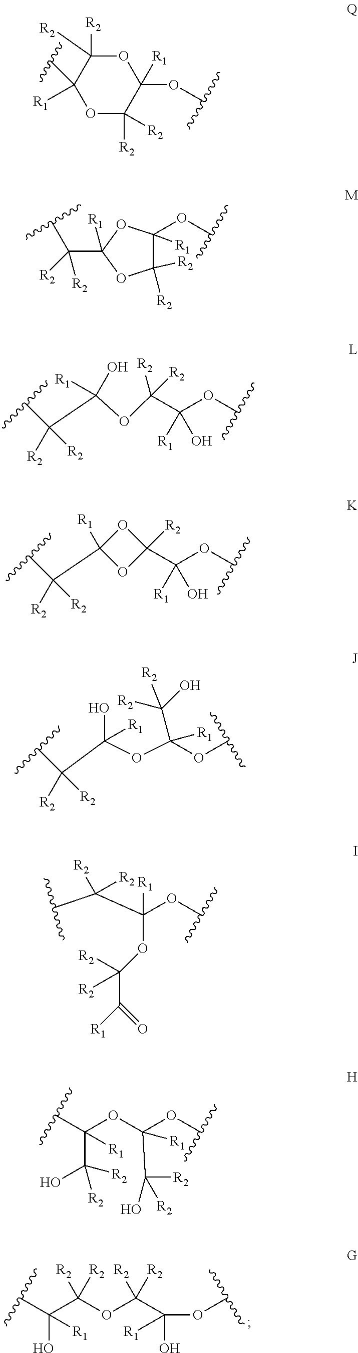

where -MDHDO- represents a combination of two or more optionally substituted glycolaldehyde dimers:

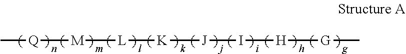

where Q, M, L, K, J, I, H and G are divalent optionally substituted glycolaldehyde dimer species as illustrated and g, h, i, j, k, l, m and n are integers from zero to 10 million, wherein at least two of g, h, i, j, k, l, m and n are different from zero and p is an integer ranging from 1-10 million.

Each R₁, R₂ and R₃ of Structure 1 is independently selected from the group consisting of hydrogen (—H), deuterium (-D), a halogen atom (—F, —Cl, —Br, —I), a hydroxyl group (—OH), an amino group (—NH₂), an alkylamino group (—NHR₉), a (bisalkylamino) group (—N(R₉)₂), an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, a haloalkyl group, a haloalkenyl group, a haloalkynyl group, an acyl group, an acyloxy group, a haloalkoxy group, an aryl group, an alkoxyaryl group, a haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C≡N), a isocyanate group (—N═C═O), an azide group (—N₃), a cyanate group (—O═C═N), a nitroso group (—NO), a phosphine group [—P(R₉)₂], a phosphate group [—OP(O)(OR₉)₂], a phosphonate group [—P(O)(OR₉)₂], a sulfate group (—O—SO₃R₉), a sulfonate group (—SO₃R₉), a thiocyanate group (—S═C═N), an iso thiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N═C(R₉)₂, and a —CR₉═NR₉; where each R₉ is independently, a hydrogen, deuterium, an alkyl, an aryl, an alkenyl or an alkynyl group, and each of R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group.

In additional embodiments of Structure 1, each R₁, R₂ and R₃ is independently optionally oligomeric, pre-polymeric or polymeric in nature and selected from the group consisting of end-capped or uncapped polyethers, poly(fluoroethers), polyglycols, polyacetals, polyolefins, polystyrene, polyfluoroolefins, polyoxides, polychlorolefins, polychlorofluoroolefins, polysiloxanes, polyesters, polybromoesters, natural and synthetic rubbers, polyols, polyalcohols, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitriles, polybutadiene, alkyds, polyurethanes, epoxies, cellulose and its derivatives, starch and its derivatives, polypeptides, and copolymers thereof.

In additional embodiments, one or both of R₃ is independently optionally oligomeric, pre-polymeric or polymeric. In embodiments, one or both of R₃ is independently oligomeric, pre-polymeric or polymeric and each of R₁ and R₂ is non-oligomeric, not pre-polymeric or non-polymeric. In embodiments, R₁, R₂ and R₃ are non-oligomeric. In embodiments, R₁, R₂ and R₃ are not pre-polymeric. In embodiments, R₁, R₂ and R₃ are non-polymeric.

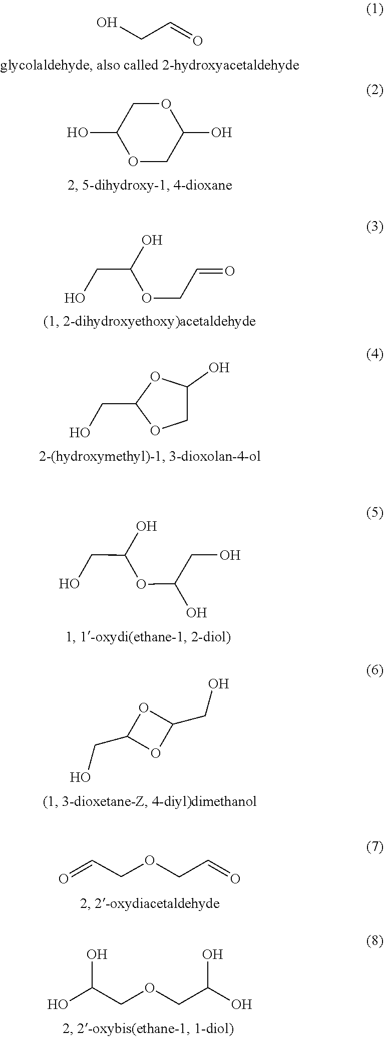

In specific embodiments of the copolymer of Structure 1, each R₁ and each R₂ are independently selected from hydrogen, deuterium, optionally substituted alkyl groups having 1-3 carbon atoms, and optionally substituted aryl groups, particularly optionally substituted phenyl or benzyl groups. In specific embodiments, each R₃ independently is hydrogen, deuterium, alkyl, acyl, acrylic, methacrylic, aminoalkylene, (alkylamino)alkylene, (bisalkylamino)alkylene, glycidyl, in particular R₅CO—, where R₉ is optionally substituted alkyl, optionally substituted alkenyl or optionally substituted aryl (for example, optionally substituted phenyl or benzyl).

In specific embodiments of the copolymer of Structure 1, each R₁ and each R₂ are hydrogen and R₃ is hydrogen, alkyl or acyl. In additional embodiments, R₁-R₃ groups include hydrogen, methyl, ethyl, n-butyl, acetyl (CH₃CO—), phenyl, benzyl, and benzoyl groups each of which is optionally substituted in embodiments with one or more halogen, an alkyl having 1-3 carbon atoms or an alkoxy having 1-3 carbon atoms.

In specific embodiments of structures herein, (n+m+l)×p ranges from 10 to 200,000. In specific embodiments, (n+m+l)×p ranges from 10 to 100,000. In specific embodiments, (n+m+l)×p ranges from 10 to 50,000. In specific embodiments, (n+m+l)×p ranges from 10 to 20,000. In specific embodiments, (n+m+l)×p ranges from 10 to 1,000. In specific embodiments, (n+m+l+k+j+i+h+g)×p ranges from 2 to 200,000. In specific embodiments, (n+m+l+k+j+i+h+g)×p ranges from 10 to 1500. In specific embodiments, (n+m+l+k+j+i+h+g)×p ranges from 20 to 120.

In embodiments of structures herein, at least two of g, h, i, j, k, l, m, or n are non-zero. In embodiments of Structure 1, three of g, h, i, j, k, 1, m, or n are non-zero. In further embodiments, at least four of g, h, i, j, k, l, m, or n are non-zero. In further embodiments, at least five of g, h, i, j, k, l, m, or n are non-zero. In further embodiments, at least six of g, h, i, j, k, 1, m, or n are non-zero. In further embodiments, at least seven of g, h, i, j, k, l, m, or n are non-zero. In embodiments, all of g, h, i, j, k, l, m, or n are non-zero. In further embodiments, l, m, and n are non-zero. In further embodiments, l, m, and n are non-zero and g, h, l, j, and k are zero. In further embodiments, l, m, and n are non-zero and (g+h+l+j+k)/(n+m+l+k+j+i+h+g) is less than 0.1. In further embodiments, l, m, and n are non-zero and (g+h+l+j+k)/(n+m+l+k+j+i+h+g) is less than 0.2. In further embodiments, (n+m+l)/(n+m+l+k+j+i+h+g) is greater than or equal to 0.5. In further embodiments, (n+m+l)/(n+m+l+k+j+i+h+g) is greater than or equal to 0.8. In embodiments, (n+m+l)/(n+m+l+k+j+i+h+g) is greater than or equal to 0.9. In further embodiments, n/(n+m+l+k+j+i+h+g) is less than or equal to 0.8. In embodiments, n/(n+m+l+k+j+i+h+g) is less than or equal to 0.9. In embodiments, n/(n+m+l+k+j+i+h+g) is less than or equal to 0.95. In embodiments, n/(n+m+l+k+j+i+h+g) is less than or equal to 0.99. In further embodiments of structures herein: (l+k+j+i+h+g)/(n+m+l+k+j+i+h+g)<0.1, m/(n+m+l+k+j+i+h+g)<0.4 and n/(n+m+l+k+j+i+h+g)>0.5. In further embodiments of structures herein, (l+j+h+g)/(n+m+l+k+j+i+h+g)<0.4, (i+m+k)+/(n+m+l+k+j+i+h+g)<0.1, and n/(n+m+l+k+j+i+h+g)>0.5. In a related aspect, the invention also provides a method of making copolymers of Structure 1 that comprises, consists essentially of or consists of polymerization of a mixture comprising two or more optionally substituted glycolaldehyde dimers in the presence of a Lewis acid catalyst.

Lewis acid catalysts include, among others, salts of iron, boron, aluminum, copper, zinc, scandium, lanthanum, yttrium, ytterbium with anions selected from the group of fluoride, chloride, bromide, iodide, triflate (CF₃SO₃⁻), and bistriflidamide ([(CF₃SO₂)₂N]⁻, perchlorate, chlorate, nitrate, tetrafluoro borate, hexaflurophosphate, tetrachloraluminate, and tetrakis(3,5-bis(trifluoromethyl)phenyl)borate. In some embodiments the Lewis acid catalyst is ZnCl₂, BF₃, SnCl₄, AlCl₃, or MeAlCl₂.

In some embodiments, the catalyst is selected from the group of scandium triflate Sc(OSO₂CF₃)₃, lanthanum triflate La(OSO₂CF₃)₃, zinc triflate Zn(OSO₂CF₃)₂, aluminum triflate Al(OSO₂CF₃)₃, iron triflate Fe(OSO₂CF₃)₃ and copper triflate Cu(OSO₂CF₃)₂.

In embodiments, the polymerization to form Structure 1 is carried out in a solvent. In embodiments, the solvent is a polar aprotic solvent. In embodiments, the solvent is an ionic liquid. In embodiments, the solvent is a mixture of polar aprotic solvent and an ionic liquid. In embodiments, the solvent is selected from acetonitrile, propionitrile, butyronitrile, 3-methoxypropionitrile, chloroform, dimethyl carbonate, ethylene carbonate, propylene, carbonate, dimethyl sulfoxide, dimethyl formamide, methylene chloride or mixtures thereof.

In embodiments, the polar aprotic solvent is anhydrous. In specific embodiments, as illustrated in Example 1D, the polar aprotic solvent contains water, e.g., a minimum of 10% by volume water. In embodiments, the polymerization is carried out in the absence of solvents either for its entire duration or a portion of it. In embodiments, the reaction is carried out either in the solid state or in solution and various methods are used to remove the byproduct of the reaction, which may include water or methanol. Methods of removing byproducts include running the reaction under reduced pressure, the use of dehydrating reagents, or by using reactors that allow the condensation of water or other solvent away from the reaction mixture, such as a Dean-Stark trap.

In general, the polymerization can be conducted at temperatures ranging from −78° C. to 120° C., dependent upon the solvent, reagents and reactants used. More specifically, the reaction is conducted at temperatures ranging from 0° C. to 80° C., yet more specifically from 5° C. to 55° C. and even more specifically from 30° C. to 45° C. The polymerization reaction is optionally carried out under reduced pressure most generally from 4 mtorr to 200 mtorr, and more specifically from 60 mtorr to 120 mtorr. The polymerization reaction can generally be carried out for any convenient time that provides desired product. It is however preferred to minimize the reaction time to achieve desired product. Generally, the reaction can be conducted from 0.5 h to 3 days, although shorter reaction times may be beneficial. In embodiments, the polymerization is carried out from 1 h to 3 days or from 6 h to 18 h or from 1 h to 6 h.

In embodiments, the polymerization reaction to prepare the polymer of Structure 1 is carried out to generate an oligomer of Structure 1 or a pre-polymer of Structure 1 which is then used as a starting material in further polymerizations as illustrated in the Examples.

In another aspect, this invention provides a copolymer composition comprising, consisting essentially of, or consisting of one or more monomers that are optionally substituted 2,5-dihydroxy-1,4-dioxanes in combination with a second monomer.

In embodiments of this aspect, the invention provides a polymer or copolymer comprising one or more monomers that are optionally substituted 2,5-dihydroxy-1,4-dioxanes in optional combination with a second monomer, where the polymer or copolymer has Structure 2:

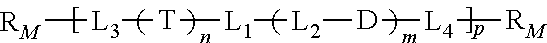

where:
D is the divalent organic radical formed on polymerization of an optionally substituted glycolaldehyde dimer;
m represents the integer number of D repeating units and generally ranges from 1 to 10 million;
T is the divalent radical formed on polymerization of a second monomer which is other than an optionally substituted glycolaldehyde dimer;
n can be 0 or an integer representing the number of T repeating units and if T is present n ranges generally from 1 to 10 million;
L₁, L₂, L₃ and L₄ are, independently, divalent linkers selected from a single bond, —O—, —CO—, —O—CO—, —CO—O—, —NH—, —NR₁₀—, —S—, —SO—, —SO₂—, —PR₁₀—, —PO—(OR₁₀)—, —O—PO(OR₁₀)—O—, and a linear or branched divalent organic radical, where R₁₀ is a monovalent organic radical or more specifically R₁₀ is an optionally substituted alkyl, alkenyl, or aryl group;
p is an integer ranging generally from 1 to 10 million or more specifically from 2 to 10 million; and
each R_{M}, independently, is R₃ or —O—R₃, where R₃ is as defined in Structure 1.

In embodiments, D is the divalent radical formed on polymerization of a mixture of one or more optionally substituted glycolaldehyde dimers. In embodiments, D is the divalent radical formed on polymerization of a mixture of two or more different optionally substituted glycolaldehyde dimers. In embodiments, D is:

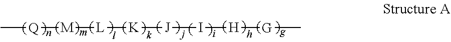

where variables are as defined for Structure 1. In embodiments, D is the divalent radical formed on polymerization of optionally substituted MDHDO or unsubstituted MDHDO. In embodiments, D is the divalent radical formed on polymerization of optionally substituted DHDO or unsubstituted DHDO.

In embodiments, m ranges from 1 to 1 million; n when not zero ranges from 1 to 1 million and p ranges from 1 to 1 million or more specifically from 2 to 1 million; and In related embodiments, the invention provides compositions comprising, consisting essentially of or consisting of one or more polymers or copolymers of structures:

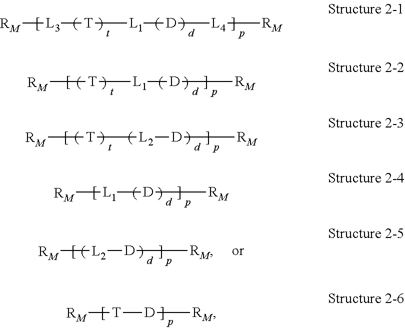

where variables are as defined in Structure 2.

In embodiments of structures 2-1, 2-2, 2-3 and 2-4, L₁ and L₂ are other than a single bond.

In specific embodiments of Structures 2-1, 2-2, 2-3, and 2-4, L₁ and L₂ are —O—CO— or —CO—O—. In specific embodiments of Structures 2-1, 2-2, 2-3, and 2-4, D is the divalent radical formed on polymerization of 2,5-dihydroxy-1,4-dioxane (e.g., structure Q).

In embodiments of Structures 2, 2-1, 2-2, 2-3 and 2-4, D is the divalent radical formed on polymerization of optionally substituted 2,5-dihydroxy-1,4-dioxane. In additional embodiments, D is formed from 2,5-dihydroxy-1,4-dioxane. In additional embodiments, D is formed from a combination of one or more of the optionally substituted glycolaldehyde dimer diradicals of Scheme 1. In additional embodiments, D is a combination of at least two of the optionally substituted dimer moieties G, H, I, J, K, L, M, or Q. In additional embodiments, D is formed from a combination of optionally substituted 2,5-dihydroxy-1,4-dioxane with at least one other optionally substituted dimer of Scheme 1. In additional embodiments, D is formed from a combination of optionally substituted 2,5-dihydroxy-1,4-dioxane with one other optionally substituted dimer of Scheme 1. In additional embodiments, each D is formed from an unsubstituted glycolaldehyde dimer.

In embodiments of Structures 2, 2-1, 2-2, 2-3 and 2-4, n is zero to indicate the absence of T and in this case, at least one of L₁, L₃ or L₄ is other than a single bond. In additional embodiments, n is zero and L₁ is —O—, —CO—, —O—CO—, —CO—O—NH—, —NR₁₀—, —S—, —SO—, —SO₂—, —PR₁₀—, —PO—(OR₁₀)—, or —O—PO(OR₁₀)—O—, where R₁₀ is a monovalent organic radical. In additional embodiments, R₁₀ is an optionally substituted alkyl, alkenyl, or aryl group. In embodiments, n is zero and L₁ is —O—CO— or —CO—O— In additional embodiments, L₂ is a single bond. In additional embodiments, L₁ is other than a single bond and L₂ is a single bond. In additional embodiments, L₁ is a single bond and L₂ is other than a single bond. In additional embodiments, L₁ and L₂ together form a single bond.

In embodiments Structures 2, 2-1, 2-2, 2-3 and 2-4, n is not zero. In additional embodiments, n is not zero and at least one of L₁, L₃ or L₄ is other than a single bond. In additional embodiments, n is not zero and L₁ is other than a single bond. In embodiments, n is not zero and L₁ is other than a single bond and L₂ is a single bond. In additional embodiments, n is not zero and L₃ is other than a single bond. In additional embodiments, n is not zero and L₄ is other than a single bond. In additional embodiments, n is not zero and L₃ and L₄ are other than a single bond. In additional embodiments, n is not zero and each of L₁, L₃ and L₄ is other than a single bond. In additional embodiments, n is not zero and each of L₁, L₃ and L₄ is other than a single bond and L₂ is a single bond. In additional embodiments, n is not zero, L₁ is other than a single bond and each of L₃ and L₄ is a single bond. In additional embodiments, n is not zero, L₁ is a single bond and either or both of L₃ and L₄ are other than a single bond. In additional embodiments, any one of L₁, L₃ or L₄ is —O—CO—. In additional embodiments, any one of L₁, L₃ or L₄ is —CO—O—. In additional embodiments, any two of L₁, L₃ or L₄ are —O—CO—. In embodiments, each of L₁, L₃ and L₄ is —O—CO—. In additional embodiments, any two of L₁, L₃ or L₄ are —CO—O—. In embodiments, each of L₁, L₃ and L₄ is —CO—O—.

In additional embodiments, n is not zero, L₁ is other than a single bond, L₂ is a single bond, and each of L₃ and L₄ is a single bond. In additional embodiments s, n is not zero, L₁ is a single bond, L₂ is a single bond and either or both of L₃ and L₄ are other than a single bond. In additional embodiments, any one of L₁, L₃ or L₄ is —O—CO— and L₂ is a single bond. In additional embodiments, any two of L₁, L₃ or L₄ are —O—CO— and L₂ is a single bond. In additional embodiments, each of L₁, L₃ and L₄ is —O—CO— and L₂ is a single bond. In additional embodiments, L₁ is a single bond and L₂ is —O—CO—. In additional embodiments, L₁ is a single bond, L₂ is —O—CO— and L₃ and L₄ are both single bonds. In additional embodiments, L₁ is —C—CO—, L₂ is a single bond and L₃ and LU are both single bonds. In additional embodiments, L₁ is —O—CO— and each of L₂, L₃ and LU are single bonds. In additional embodiments, L₁ is a single bond, L₂ is —O—CO— and each of L₃ and L₄ are other than single bonds. In additional embodiments, L₁ is a single bond, L₂ is —O—CO— and each of L₃ and L₄ are other than single bonds. In additional embodiments, each of L₁ and L₂ is a single bond (L₁ and L₂ together are a single bond) and each of L₃ and L₄ are other than a single bond.

In embodiments of Structures 2, 2-1, 2-2, 2-3 and 2-4, the divalent organic radical of L₁-L₄ is selected from an optionally substituted linear or branched divalent alkyl radical, an optionally substituted divalent aromatic radical, an optionally substituted divalent heteroaromatic aromatic radical, an optionally substituted divalent oligomeric radical, or an optionally substituted divalent polymeric radical. In additional embodiments, the divalent organic radical is —(CH₂)ₐ—, where a is an integer ranging from 1-20 (or 1-10, or 1-6, or is 1, 2 or 3). In additional embodiments, the divalent organic radical is —(CH₂)ₐ—O—(CH₂)ᵣ—, where a and b, independently range from 1-20 (or 1-10, or 1-6, or are each independently 1, 2 or 3). In additional embodiments, the divalent organic radical is an optionally substituted phenylene, particularly an optionally substituted 1, 4-phenylene.

In embodiments of structures herein, the second monomer (from which T is formed) is selected from any monomer that can react with a OH group to form the desired polymer. Non-limiting examples of molecules that can be used as the second monomer include: monosaccharides, disaccharides, oligosaccharides, polysaccharides, diols, polyols, compounds containing one, two or more carboxylic acid groups, hydroxyacids, aminoacids, compounds containing one, two or more carboxylic acid ester groups, compounds containing one, two or more acyl chloride groups, compounds containing one, two or more acyl bromide groups, compounds containing one, two or more isocyanate groups, compounds containing one, two or more oxirane groups, compounds containing one, two or more isothiocyanate groups, compounds containing one, two or more nitrile groups, compounds containing one, two or more azide groups, phosgene, dialkyl carbonates, dialkyl dichlorosilanes, or diaryidichlorosilanes. In embodiments, the second monomer is other than a dimer of an alpha-hydroxycarbonyl compound. In embodiments, the second monomer is other than a dimer of an alpha-hydroxyaldehyde or an alpha-hydroxyketone. In embodiments, the second monomer is an alpha-hydroxycarbony. In specific embodiments, the second monomer is an alpha-hydroxyketone. In specific embodiments, the second monomer is hydoxyacetone. In specific embodiments, the second monomer is lactaldehyde.

In another embodiment, the second monomer is a di- tri- or poly-isocyanate. Diisocyanates include among others methylenebis(phenyl isocyanate) (MDI), toluene diisocyanate (TDI), and hexamethylene diisocyanate (HDI), naphthalene diisocyanate (NDI), methylene bis-cyclohexylisocyanate (HMDI)(hydrogenated MDI), and isophorone diisocyanate (IPDI), tetramethylxylidene diisocyanate (TMXDI), their isomers, dimers, trimers, biuret and isocyanurate derivatives.

In yet another embodiment, T is formed from a reagent that will form a carbonate group upon reaction, including but not limited to, phosgene, urea, urea derivatives, a dialkyl carbonate and more specifically dimethyl carbonate, a alkylene carbonate, diphosgene, triphosgene, carbonyl diimidazole, disuccinimidyl carbonate, or carbon monoxide.

In yet another embodiment, T is formed by reaction of alkyl diacid, an ester thereof, or an anhydride thereof, or a diacid halide, particularly a diacid chloride thereof.

This invention also provides copolymer compositions comprising, consisting essentially of, or consisting of monomer units formed from one or more glycolaldehyde dimer selected from the group of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde and a second monomer that is not a glycolaldehyde dimer.

The second monomer may be selected as described above from any monomer that can react with a OH group to form the desired polymer. Non limiting examples of molecules that can be used as the second monomer include: polysaccharides, monosaccharides, disaccharides, oligosaccharides, polysaccharides, diols, polyols, compounds containing two or more carboxylic acid groups, hydroxyacids, aminoacids, compounds containing two or more carboxylic acid ester groups, compounds containing two or more acyl chloride groups, compounds containing two or more acyl bromide groups, compounds containing two or more isocyanate groups, compounds containing two or more oxirane groups, compounds containing two or more isothiocyanate groups, compounds containing two or more nitrile groups, compounds containing two or more azide groups, phosgene, dialkyl carbonates, dialkyl dichlorosilanes, and diaryldichlorosilanes. The repeating unit of the second monomer can for example be selected from M3, or M4 or those formed from diacids, diesters, diacid halides or diisocyanates of M5-M13.

The invention provides polymers and copolymers of Structures 1, 1-2, 2, 2-1, 2-2, 2-3, 2-4, 2-5, 2-6, 3, 3-1, 3-2, 3-3, 3-4, 3-5, 4, 4-1, 4-2, 5, 5-1, 5-2, 6, 6-1, and/or 6-2 and methods of making these polymer and copolymers. The invention provides random copolymers of Structures 1, 1-2, 2, 2-1, 2-2, 2-3, 2-4, 2-5, 2-6, 3, 3-1, 3-2, 3-3, 3-4, 3-5, 4, 4-1, 4-2, 5, 5-1, 5-2, 6, 6-1, and/or 6-2 and methods of making these polymer and copolymers. The invention provides block copolymers of Structures 1, 1-2, 2, 2-1, 2-2, 2-3, 2-4, 2-5, 2-6, 3, 3-1, 3-2, 3-3, 3-4, 3-5, 4, 4-1, 4-2, 5, 5-1, 5-2, 6, 6-1, and/or 6-2.

Additional aspects and embodiments of the invention will be apparent to one of ordinary skill in the art on review of the detailed description, drawings and the non-limiting examples.

### BRIEF DESCRIPTION OF THE DRAWINGS

FIG. 1: ¹H-NMR spectrum of polyacetal made by polymerization of a raw material blend comprising >90% by wt of 2,5-dihydroxy-1,4-dioxane and the reminder <10% wt. being a mixture of 2-(hydroxymethyl)-1,3-dioxolan-4-ol, 1,1′-oxydi(ethane-1,2-diol) and 1,2-dihydroxyethoxyacetaldehyde an example of MPDHDO.

FIG. 2: ¹H-NMR spectrum of polyacetal (PDHDO) from pure 2,5-Dihydroxy-1,4-dioxane (DHDO).

### DETAILED DESCRIPTION

### Definitions

In general, the terms and phrases used in this specification have the meaning recognized in the art, which can be found by reference to standard texts, journal references and contexts known to those skilled in the art. For clarity, the following terms have the following meaning unless otherwise specified.

It will be understood by one of ordinary skill in the art that single numeric values or numeric values in a range, include slight variations or deviations from the stated value which may be used to achieve substantially the same results as the stated value. In cases, where a numeric value is one that is measured, it will be recognized that there is some level of uncertainty in the stated value due to experimental error, which can be determined by one of ordinary skill in the art. In circumstances where this definition cannot be applied to a given stated value, is exceedingly difficult to apply, or wherein an uncertainty value is not specifically recited, then the numeric value has a reasonable deviation from the value, as known to a skilled person in the art. In embodiments, the reasonable deviation for a given value is +/−10% unless otherwise indicated.

Glycolaldehyde is also known as 2-hydroxyacetaldehyde and has formula CHO—CH₂—OH.

Glycolaldehyde dimers include all dimeric forms of glycolaldehyde. Glycolaldehyde dimers include linear dimers and cyclic dimers, including six member cyclic dimers, five member cyclic dimers and four member cyclic dimers. Glycolaldehyde dimers include but are not limited to 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde and mixtures thereof. Some examples of glycolaldehyde dimers are shown in Scheme 1.

A monovalent organic radical is a radical formally obtained by the removal of a hydrogen atom from an organic molecule. Non limiting examples of monovalent organic radical include, methyl, ethyl, propyl, isopropyl, butyl, pentyl, hexyl, heptyl, phenyl, aryl, alkyl, alkenyl, alkoxy, alkylcarbonyl, akanoyl, alkylthio, cycloalkyl, cycloalkoxy, alkyloxy, alkenyloxy, alkenyldioxy, acyl, aryl, alkylaryl, arylalkyl, aryloxy, amino, alkylamino, dialkylamino, alkylcarbonylamino, alkylsulfinyl, aryloxyalkyl, alkoxylalkyl, heterocyclic, heteroaryl, polyetheralkyl, fluorinated alkyl, perfluoralkyl, sulfonate, alkylsulfonate, arylsulfonate, alkylsulfate, arylsulfate, nitroalkyl, alkylsilyl, and arylsilyl. In general, an organic radical can contain any number of carbon atoms. In embodiments, organic radicals contain 1-100, 1-50, 1-20, 1-10, 1-6 or 1-3 carbon atoms. In embodiments, organic radicals can contain 1-6 heteroatoms (e.g., O, N, S or P). In specific embodiments, organic radicals include alkyl, alkenyl, alkoxyl (alkyloxy), acyl, alkylamino, dialkylamino, alkylsulfinyl, haloalkyl and fluoroalkyl groups having 1-6 or 1-3 carbon atoms. In specific embodiments, organic radicals include aryl, alkylaryl, cycloalkyl, heterocyclic, and heteroaryl groups having 3-20 carbon atoms (or 3-10 or 6-carbon atoms and up to 4 heteroatoms.

Additional examples of monovalent organic radicals formally obtained by the removal of a hydrogen atom from an oligomeric or polymeric chain made by repeating one or more monomers selected from glycols, ethers, fluoroethers, olefins, fluoroolefins, acrylates and methacrylates, vinyl groups alkynes, esters, amino acids, lactones and lactams, urethanes, epoxies, hydroxyacids, dienes, chloroolefins, diols, diamines, polyamines, groups containing acrylates or methacrylates, groups containing esters, ethers, hydroxyls, epoxies or amines, epoxidized groups, ring-opened epoxy groups, polyglycols, polyethylene glycol, polyethers, poly(fluoroethers), polyacetals, polyenes, polyolefins, polystyrene and its copolymers, polyfluoroolefins, polyoxides, polychloroolefins, polychlorofluoroolefins, polysiloxanes, polyesters, polybromoesters, natural and synthetic rubbers, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitrile and its copolymers, polybutadiene and its copolymers, alkyds, polyols, polyalcohols, polyurethanes, epoxies, cellulose and its derivatives, starch and its derivatives, polypeptides, oligonucleotides, nucleotides, oligosaccharides, polysaccharides, and combinations and copolymers thereof. One or more carbons of an organic radical are optionally substituted.

A divalent organic radical (also called a bivalent organic radical) is a radical formally obtained by the removal of two hydrogen atoms from an organic molecule, oligomer or polymer. Non limiting examples of divalent organic radicals include —(CH₂)ₙ— (where in embodiments n ranges from 1-20), alkylenes, arylenes, optionally substituted alkylene, methylene, linear alkylene, cyclic alkylene groups, alkenylene, and arylene groups, optionally substituted ether or polyether groups, optionally substituted thioether or polythioether groups. In general, a divalent organic radical can contain any number of carbon atoms. In embodiments, divalent organic radicals contain 1-100, 1-50, 1-20, 1-10, 1-6 or 1-3 carbon atoms. In embodiments, divalent organic radicals can contain 1-6 heteroatoms (e.g., O, N, S or P).

Divalent organic radicals also include species formally resulting from removing two hydrogen atoms from an oligomer or a polymer chain made by repeating one or more monomers selected from glycols, ethers, fluoroethers, olefins, fluoroolefins, acrylates and methacrylates, vinyl groups alkynes, esters, amino acids, lactones and lactams, urethanes, epoxies, hydroxyacids, dienes, chloroolefins, diols, diamines, polyamines, groups containing acrylates or methacrylates, groups containing esters, ethers, hydroxyls, epoxies or amines, epoxidized groups, ring-opened epoxy groups, polyglycols, polyethylene glycol, polyethers, poly(fluoroethers), polyacetals, polyenes, polyolefins, polystyrene and its copolymers, polyfluoroolefins, polyoxides, polychloroolefins, polychlorofluoroolefins, polysiloxanes, polyesters, polybromoesters, natural and synthetic rubbers, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitrile and its copolymers, polybutadiene and its copolymers, alkyds, polyols, polyalcohols, polyurethanes, epoxies, cellulose and its derivatives, starch and its derivatives, polypeptides, oligonucleotides, nucleotides, oligosaccharides, polysaccharides, and combinations and copolymers thereof.

A polymer is a substance composed of very large molecules, called macromolecules, that are multiples of simpler chemical units called monomers. Monomers polymerize to form multiples of repeating units in the polymer. Polymers can be linear, branched or crosslinked. It will be appreciated that polymers most often contain a mixture of polymer molecules with varying degrees of polymerization (i.e., varying numbers of repeating units).

A copolymer is a polymer derived from more than one species of monomer. Copolymers can be alternating, random and block copolymers. In a random copolymer, the monomer units derived from different monomers are arranged in a random sequence along the polymer chain. In an alternating polymer, monomer units derived from two different monomers alternate in sequence along the polymer chain. Alternating copolymers are often illustrated as having an ABABAB or (AB)ₙ type structure. In embodiments herein, alternating copolymers can be formed when the A unit is formed from a glycolaldehyde dimer (e.g., 2, 5-dihydroxy-1, 4-dioxane) and the B unit is formed from either a diacid (or derivative thereof) or a diisocyanate or CO₂. A block copolymer is a polymer composed of two or more chemically distinct homopolymer blocks linked together.

A prepolymer or pre-polymer refers to a monomer or system of monomers that have been reacted to an intermediate-molecular mass state. A prepolymer is capable of further polymerization by reaction with reactive groups, e.g., with a second monomer or mixture of monomers, to a fully cured, high-molecular-mass state. Prepolymer are also called resins. OH terminated, prepolymers are also called polyols. The useful size of a prepolymer depends on specific polymerizations to be carried out as well as the desired polymerized product. Often viscosity, solubility, miscibility and reactivity with the second monomer or mixture of monomers are important factors for selection of prepolymer size. In embodiments of this invention, prepolymers nominally include species with two or more of the same or different repeating units and extend up to species having 1,000 or more repeating units. In embodiments of this invention, the size of the prepolymer can vary widely. In embodiments, prepolymers used in polymerizations herein range in size from 3 to 1000 repeating units. In specific embodiments, prepolymers herein range in Mw from 300 to 8,000 D. Specific polymers and prepolymers of this invention include PDHDO (polymerized optionally substituted DHDO, where -DHDO- is the corresponding diradical formed on polymerization) and PMDHDO (polymerized optionally substituted MDHDO, where -MDHDO- is the diradical formed on polymerization of a mixture of two or more glycolaldehyde dimers as shown in Structure A. More specific polymers and prepolymers include PDHDO and PMDHDO having from 3-1000 repeating units or more specifically having Mw ranging from 300 to 8,000 D.

Oligomer is used to describe species having a few monomer units linked together. For clarity herein, the term oligomer refers to species containing 10 or fewer monomer units. Oligomers can contain repeating units that are all the same or two or more different repeating units. In certain cases, oligomers and prepolymer are synonymous. For example, an oligomer can be used as a starting material in a polymerization reaction. For use herein, the term prepolymer is used for an intermediate compound used for further polymerization (including species of the size of oligomers) and the term oligomer refers to a final product.

Weight average molecular weight (Mw) of a polymer or copolymer is typically determined by Gel Permeation Chromatography (GPC) using a refractive index detector coupled with data collection software. Molecular weights (Mw, Mn, Mz) and the distribution of polymers are determined based on a calibration curve with monodisperse polymer standards of known molecular weight. Molecular weight determination by GPC analysis is well-known in the art. However, other methods for measurement of Mw, Mn and Mz can be employed to characterize polymers and copolymers of this invention.

Polydispersity index (PDI) is a measure of the breadth of molecular weight distribution in a polymer. PDI (also designated molar-mass dispersity) is calculated as the ratio of weight average molecular weight (Mw) to the number average molecular weight (Mn), i.e. Mw/Mn. A PDI of 1 (its lowest value) indicates that all polymers have the same chain length. PDI of synthetic polymers generally varies dependent upon the mechanism of the polymerization reaction and upon the reaction conditions and most often is greater than 1. Most often, PDI ranges up to 20. Uniformity of polymer properties generally increases with decreasing PDI. In embodiments, the methods herein provide polymers with PDI less than 10 and more preferably less than 5. In specific embodiments, methods herein provide polymers with PDI of less than 3, less than 2.5 or less than 2.

An alpha hydroxyaldehyde (α-hydroxyaldehyde) is a chemical compound that comprises an aldehyde group and a hydroxyl group substituent on the adjacent (alpha) carbon to the aldehyde group. Examples of this group include glycolaldehyde, lactaldehyde, and mandelic aldehyde. Alpha hydroxyaldehydes may exist in one or more dimer forms.

An aloha hydroxyketone-(α-hydroxyketone) is a chemical compound that comprises an aldehyde ketone group and a hydroxyl group substituent on the adjacent (alpha) carbon to the ketone group. Examples of this group include hydroxyacetone and dihydroxyacetone.

The term monosaccharide is used herein to refer generally to a sugar monomer in any form. Examples of monosaccharides include glucose, fructose and galactose.

The term disaccharide is used to refer to a sugar dimer formed when two monosaccharides are joined by a glycosidic linkage and includes any forms thereof. Sucrose, lactose, and maltose are examples of disaccharides.

The term oligosaccharide is used herein to refer to a sugar oligomer having 3-10 sugar monomers in any form joined by glycosidic linkages.

The term polysaccharide is used herein generally to refer to a polymer of sugar monomers of any form joined by glycosidic linkages and having more than 10 sugar monomers.

PDHDO refers to a polymer including a prepolymer of Structure 1 wherein n is non-zero and all of m, l, k, j, i, g and h are zero, the polymer contains the Q repeating unit. DHDO units (-DHDO-) in PDHDO can be substituted or unsubstituted.

PMDHDO (mixed PDHDO) refers to a copolymer including a prepolymer of Structure A wherein at least two of n, m, l, k, j, i, g and h are non-zero. In embodiments, n, m and l are non-zero.

DHDO refers to 2, 5-dihydoxy-1, 4-dioxane which may be optionally substituted. Unsubstituted DHDO of different purities is used in examples herein. The diradical formed by polymerization of optionally substituted DHDO is -DHDO-.

MDHDO refers to a mixture of monomers of optionally substituted glycolaldehyde dimers. The diradical formed by polymerization of a mixture of optionally substituted glycolaldehyde dimers is -MDHDO- (this diradical contains at least two different optionally substituted glycolaldehyde dimers).

As is known in the art, acrylates (also called prop-2-enoates) include salts, esters and conjugate bases of acrylic acid. The acrylate group is CH₂═CH—CO₂—. Similarly, methacrylates include salts, esters and conjugate bases of methacrylic acid. The methacrylate group is CH₂═C(CH₃)—CO₂—.

This invention provides copolymers of glycolaldehyde dimers including alternating, random and block copolymers of glycolaldehyde dimers. Copolymers of this invention may be linear, branched or crosslinked. Copolymers of glycolaldehyde dimers of this invention include copolymers in which the glycolaldehyde dimer exists in either its linear forms, six-member cyclic form, five-member cyclic form, four-member ring form or a mixture of two or more forms. Copolymers of glycolaldehyde dimer include those in which the dimer is in the form of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde (see Scheme 1) and mixture thereof. Copolymers of this invention include copolymers in which all the monomers are different forms of glycolaldehyde dimers, and copolymers in which one or more glycolaldehyde dimers or two or more glycolaldehyde dimers are reacted with one or more other, chemically different, comonomers.

In one aspect, the invention provides copolymers of Structure 1:

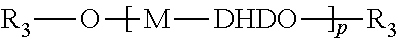

which in more detail is written as:

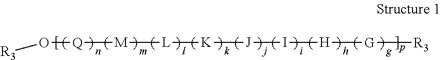

where:

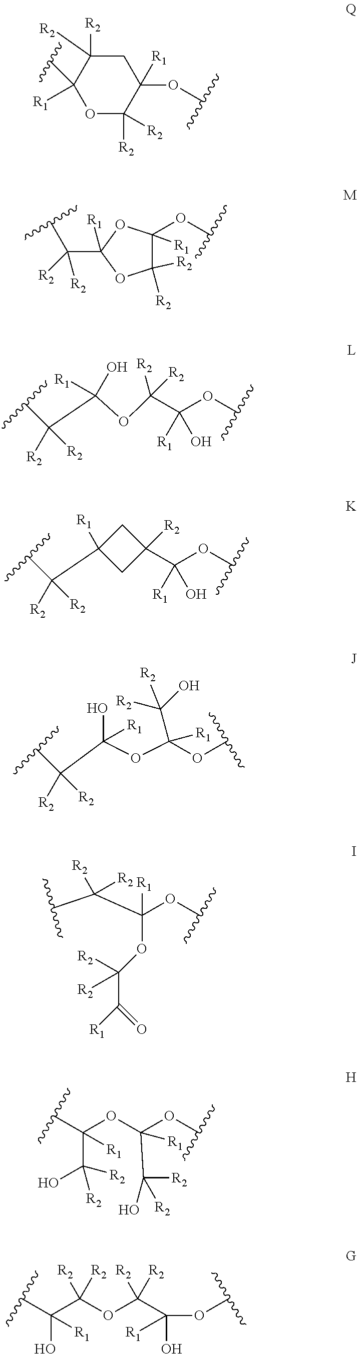

where Q, M, L, K, J, I, H and G are divalent glycolaldehyde dimer species as illustrated and g, h, i, j, k, l, m and n are integers from zero to 10 million, wherein at least two of g, h, i, j, k, l, m and n are different from zero and p is an integer ranging from 1-10 million.

In embodiments, g, h, i, j, k, l, m and n are integers from zero to 1 million, wherein at least two of g, h, i, j, k, l, m and n are different from zero and p is an integer ranging from 1-1 million.

In embodiments, the polymer of structure 1 is a random copolymer.

Each R₁, R₂ and R₃ of Structure 1 is independently selected from the group consisting of hydrogen (—H), deuterium (-D), an halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C≡N), a isocyanate group (—N═C═O), a azide group (—N₃), a cyanate group (—O═C═N), a nitroso group (—NO), a phosphine group [—P(R₉)₂], a phosphate group [—OP(O)(OR₉)₂], a phosphonate group [—P(O)(OR₉)₂], a sulfate group (—O—SO₃R₉), a sulfonate group (—SO₃R₉), a thiocyanate group (—S═C═N), a iso thiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N═C(R₉)₂, and a —CR₉═NR₉; where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group.

In additional embodiments, each R₁, R₂ and R₃ is independently optionally oligomeric, pre-polymeric or polymeric in nature and selected from the group consisting of end-capped or uncapped polyethers, poly(fluoroethers), polyglycols, polyacetals, polyolefins, polystyrene, polyfluoroolefins, polyoxides, polychlorolefins, polychlorofluoroolefins, polysiloxanes, polyesters, polybromoesters, natural and synthetic rubbers, polyols, polyalcohols, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitriles, polybutadiene, alkyds, polyurethanes, epoxies, cellulose and its derivatives, starch and its derivatives, polypeptides, and copolymers thereof.

In embodiments, one or both of R₃ is independently optionally oligomeric, pre-polymeric or polymeric. In embodiments, one or both of R₃ is independently oligomeric, pre-polymeric or polymeric and each of R₁ and R₂ is non-oligomeric, not pre-polymeric or non-polymeric. In embodiments, R₁, R₂ and R₃ are non-oligomeric. In embodiments, R₁, R₂ and R₃ are not pre-polymeric. In embodiments, R₁, R₂ and R₃ are non-polymeric.

In specific embodiments of the copolymer of Structure 1, each R₁ and each R₂ are independently selected from H, D, optionally substituted alkyl groups having 1-3 carbon atoms, and optionally substituted aryl groups, particularly optionally substituted phenyl or benzyl groups. In specific embodiments, each R₃ independently is hydrogen, deuterium, alkyl, acyl, acrylic, methacrylic, glycidyl, aminoalkylene, (alkylamino)alkylene, (bisalkylamino)alkylene, in particular R₉CO—, where R₉ is optionally substituted alkyl, optionally substituted alkenyl or optionally substituted aryl (for example, optionally substituted phenyl or benzyl).

In specific embodiments of the copolymer of Structure 1, each R₁ and each R₂ are hydrogen and R₃ is hydrogen, alkyl or acyl.

In embodiments, R₁-R₃ groups include hydrogen, methyl, ethyl, n-butyl, acetyl (CH₃CO—), phenyl, benzyl, and benzoyl groups each of which is optionally substituted in embodiments with one or more halogen, an alkyl having 1-3 carbon atoms or a alkoxy having 1-3 carbon atoms.

In specific embodiments, (n+m+l)×p ranges from 10 to 200,000. In specific embodiments, (n+m+l)×p ranges from 10 to 100,000. In specific embodiments, (n+m+l)×p ranges from 10 to 50,000. In specific embodiments, (n+m+l)×p ranges from 10 to 20,000. In specific embodiments, (n+m+l)×p ranges from 10 to 1,000. In specific embodiments, (n+m+l+k+j+i+h+g)×p ranges from 10 to 1500. In specific embodiments, (n+m+l+k+j+i+h+g)×p ranges from 20 to 120.

In embodiments of Structure 1, at least two of g, h, i, j, k, l, m, or n are non-zero. In embodiments of Structure 1, three of g, h, i, j, k, l, m, or n are non-zero. In embodiments of Structure 1, at least four of g, h, i, j, k, l, m, or n are non-zero. In embodiments of Structure 1, at least five of g, h, i, j, k, l, m, or n are non-zero. In embodiments of Structure 1, at least six of g, h, i, j, k, l, m, or n are non-zero. In embodiments of Structure 1, at least seven of g, h, i, j, k, l, m, or n are non-zero. In embodiments of Structure 1, all of g, h, i, j, k, l, m, or n are non-zero. In embodiments of Structure 1, 1, m, and n are non-zero. In embodiments of Structure 1, 1, m, and n are non-zero and g, h, l, j, and k are zero. In embodiments of Structure 1, l, m, and n are non-zero and (g+h+l+j+k)/(n+m+l+k+j+i+h+g) is less than 0.1. In embodiments of Structure 1, 1, m, and n are non-zero and (g+h+l+j+k)/(n+m+l+k+j+i+h+g) is less than 0.2. In embodiments, (n+m+l)/(n+m+l+k+j+i+h+g) is greater than or equal to 0.5. In embodiments, (n+m+l)/(n+m+l+k+j+i+h+g) is greater than or equal to 0.8. In embodiments, (n+m+l)/(n+m+l+k+j+i+h+g) is greater than or equal to 0.9. In embodiments, n/(n+m+l+k+j+i+h+g) is less than or equal to 0.8. In embodiments, n/(n+m+l+k+j+i+h+g) is less than or equal to 0.9.

In further embodiments, Structure 1 has (l+k+j+i+h+g)/(n+m+l+k+j+i+h+g)<0.1, m/(n+m+l+k+j+i+h+g)<0.4 and n/(n+m+l+k+j+i+h+g)>0.5. In further embodiments, Structure 1 has (l+j+h+g)/(n+m+l+k+j+i+h+g)<0.4, (i+m+k)+/(n+m+l+k+j+i+h+g)<0.1, and n/(n+m+l+k+j+i+h+g)>0.5.

Other embodiments of this aspect of the invention include copolymers of Structure 1-2:

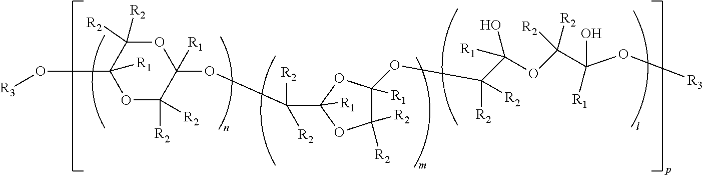

where:
R₁, R₂ and R₃ are as defined in the various embodiments of Structure 1;
n, m and l are as defined in the various embodiments of Structure 1; and
p is a positive integer, which in embodiments ranges from 1 to 10 million.

In embodiments, at least two of n, m or l are non-zero. In embodiments, p ranges from 1-1 million. In embodiments, p is 2 or more.

In embodiments, copolymers of Structure 1-2 have 1/(n+m+l)<0.1, m/(n+m+l)<0.4 and n/(n+m+l)>0.5. In embodiments, copolymers of Structure 2 have l/(n+m+l)<0.01, m/(n+m+l)<0.1 and n/(n+m+l)>0.9. In embodiments, copolymers of Structure 2 have l/(n+m+i)<0.01, m/(n+m+l)<0.1 and n/(n+m+l)>0.95. In embodiments, copolymers of Structure 2 have l/(n+m+i)<0.01, m/(n+m+l)<0.1 and n/(n+m+l)>0.99. In embodiments, each R₁ and R₂ are independently selected from hydrogen, methyl, ethyl, n-butyl, acetyl (CH₃CO—), phenyl, and benzoyl groups. In embodiments, each R₃ is independently selected from hydrogen, acyl, acetyl, phenyl, and benzoyl groups. In specific embodiments, each R₁ and R₂ is independently selected from hydrogen, methyl, ethyl, propyl, n-butyl and each R₃ is independently selected from hydrogen and acetyl.

Copolymers of Structure 1 and 1-2 include those having weight average molecular weight (Mw) equal to or greater than 15,000 Da, preferably greater than 15,000 Da (15 kDa), preferably equal to or greater than 20,000 Da, more preferably equal to or greater than 25,000 Da and most preferably equal to or greater than 30,000 Da. In embodiments, the upper limit of Mw of these polymers or copolymers is 50,000 Da, 75,000 Da, 100,000 Da, 500,000 Da or 1,000,000 Da. In embodiments, the Mw of the copolymers of structures herein ranges from 15,000 Da to 100,000 Da, 20,000 Da to 100,000 Da, 25,000 Da to 100,000 Da, or 30,000 Da to 100,000 Da. In embodiments, the Mw of the copolymers of structures herein ranges from 15,000 Da to 50,000 Da, 20,000 Da to 50,000 Da, 25,000 Da to 50,000 Da, or 30,000 Da to 50,000 Da. In embodiments, the Mw of the copolymers of structures herein ranges from 15,000 Da to 40,000 Da, 15,000 Da to 35,000 Da, 15,000 Da to 25,000 Da, or 15,000 Da to 30,000 Da.

In embodiments, copolymers of this invention have weight average molecular weight (Mw) equal to or greater than 15,000 Da, preferably greater than 15,000 Da (15 kDa), preferably equal to or greater than 20,000 Da, more preferably equal to or greater than 25,000 Da and most preferably equal to or greater than 30,000 Da. In embodiments, the upper limit of Mw of these polymers or copolymers is 50,000 Da, 75,000 Da, 100,000 Da, 500,000 Da or 1,000,000 Da. In embodiments, the Mw of polymers and copolymers herein ranges from 15,000 Da to 100,000 Da, 20,000 Da to 100,000 Da, 25,000 Da to 100,000 Da, or 30,000 Da to 100,000 Da. In embodiments, the Mw of the polymers and copolymers herein ranges from 15,000 Da to 50,000 Da, 20,000 Da to 50,000 Da, 25,000 Da to 50,000 Da, or 30,000 Da to 50,000 Da. In embodiments, the Mw of the polymers and copolymers herein ranges from 15,000 Da to 40,000 Da, 15,000 Da to 35,000 Da, 15,000 Da to 25,000 Da, or 15,000 Da to 30,000 Da.

PDI of synthetic polymers generally varies dependent upon the mechanism of the polymerization reaction and upon the reaction conditions and most often is greater than 1. Most often, PDI ranges up to 20. Uniformity of polymer properties generally increases with decreasing PDI. In embodiments, the polymers and copolymers herein exhibit PDI less than 10 and more preferably less than 5. In specific embodiments, polymers and copolymers herein exhibit PDI of less than 3, less than 2.5 or less than 2.

In another aspect, the invention provides a polymer or copolymer comprising one or more monomers that are optionally substituted glycolaldehyde dimers, particularly optionally substituted 2,5-dihydroxy-1,4-dioxanes in optional combination with a second monomer, where the polymer or copolymer has Structure 2:

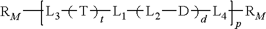

where:
D is an optionally substituted glycolaldehyde dimer;
d represents the positive integer number of optionally substituted glycolaldehyde dimers and generally ranges from 1 to 10 million or more specifically ranges from 2 to 10 million;
T is a divalent radical formed on polymerization of a second monomer, where the second monomer is other than an optionally substituted glycolaldehyde dimer;
t is 0 or a positive integer representing the number of T monomer units and, if T is present, t generally ranges generally from 1 to 10 million and more specifically ranges from 2 to 10 million;
L₁, L₂, L₃ and L₄ are, independently, divalent linkers selected from a single bond, —O—, —CO—, —O—CO—, —CO—O—, —NH—, —NR₁₀—, —S—, —SO—, —SO—, —PR₁₀—, —PO—(OR₁₀)—, —O—PO(OR₁₀)—O—, and a linear or branched divalent organic radical;
p is an integer represents the number of illustrated repeating units and ranges generally from 1 to 10 million or more specifically from 2 to 10 million; and each R_{M}, independently, is Rₛ or —O—R₉, where Rₛ is as defined in Structure 1.

In embodiments, p ranges from 1 to 1 million. In embodiments, t ranges from 1-1 million or from 2-1 million. In embodiments, d ranges from 1 to 1 million or from 2 to 1 million. In embodiments, D is one or more optionally substituted glycolaldehyde dimer. In embodiments, D is a mixture of two or more different optionally substituted glycolaldehyde dimers. In embodiments, D is:

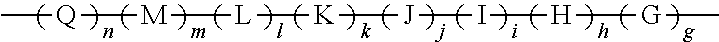

where variables are as defined for Structure 1. In embodiments, D is -MDHDO-. In embodiments, D is -DHDO-.

In embodiments of Structure 2, t, d and p independently range from 1-500,00, 1-250,000, 1-100,000, 1-10,000, 1-5,000, 1-2,500, 1-1,000, 1-500, 1-250, 1-100, 1-50, or 1-10. In embodiments, t and d range from 1-10, 2-20, 1-100, 2-100, 1-500, or 2-500. In embodiments, p ranges from 1-100, 2-100, 1-500, 2-500, 1-1,000, 2-1,000, 1-10,000, 2-100,000, 1-100,000 or 2-100,000. In embodiments, t is greater than d. In embodiments, d is greater than t. In embodiments, t+d is less than p. In embodiments, t+d is greater than p. In embodiments, (t+d)p is greater than 10, greater than 100, greater than 1,000, greater than 10,000, greater than 100,000 or greater than 1 million, but less than 100 million, or less than 10 million. In embodiments, (t+d)p is less than 10,000, or less than 5,000, or less than 1,000, or less than 500, or less than 100, or less than 50.

In related embodiments, the invention provides compositions comprising, consisting essentially of or consisting of one or more polymers or copolymers of structures:

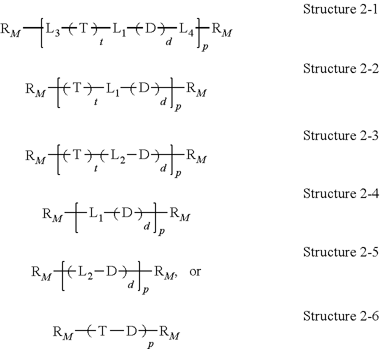

where variables are as defined in Structure 2.

In embodiments, L₁ and L₂ are other than single bonds.

In specific embodiments of Structures 2-1, 2-2, 2-3, 2-4, and 2-5, L₁ and L₂ are —O—CO— or —CO—O—. In specific embodiments of Structures 2-1, 2-2, 2-3, 2-4, and 2-5, D is 2,5-dihydroxy-1,4-dioxane.

In embodiments of Structures 2, 2-1, 2-2, 2-3, 2-4, and 2-5, D is optionally substituted 2,5-dihydroxy-1,4-dioxane. In additional embodiments, D is unsubstituted 2,5-dihydroxy-1,4-dioxane. In additional embodiments, D is a combination of one or more of the optionally substituted glycolaldehyde dimers of Scheme 1. In additional embodiments, D is a combination of at least two of the optionally substituted dimer moieties G, H, I, J, K, L, M, or Q. In additional embodiments, D is a combination of optionally substituted 2,5-dihydroxy-1,4-dioxane with at least one other optionally substituted dimer of Scheme 1. In additional embodiments, D is a combination of optionally substituted 2,5-dihydroxy-1,4-dioxane with one other optionally substituted dimer of Scheme 1. In additional embodiments, each D is an unsubstituted glycolaldehyde dimer.

In embodiments of Structures 2, 2-1, 2-2, and 2-3, t is zero to indicate the absence of T and in this case, at least one of L₁, L₃ or L₄ is other than a single bond. In additional embodiments, t is zero and L₁ is —O—, —CO—, —O—CO—, —CO—O—, —NH—, —NR₁₀—, —S—, —SO—, —SO₂—, —PR₁₀—, —PO—(OR₁₀)—, or —O—PO(OR₁₀)—O—, where R₁₀ is a monovalent organic radical. In additional embodiments, R₁₀ is an optionally substituted alkyl, alkenyl, or aryl group. In embodiments, t is zero and L₁ is —O—CO—. In additional embodiments, L₂ is a single bond. In additional embodiments, L₁ is other than a single bond and L₂ is a single bond. In additional embodiments, L₁ is a single bond and L₂ is other than a single bond. In additional embodiments, L₁ and L₂ together form a single bond.

In embodiments of Structures 2, 2-1, 2-2, and 2-3, the ratio of t/d ranges from 0.01 to 100. In additional embodiments, the ration of t/d ranges from 0.1 to 10. In embodiments, the ratio of t/d ranges from 0.2 to 5. In embodiments, the ratio of t/d ranges from 0.5 to 2. In embodiments, the ratio of t/d is 1+/−10%.

In embodiments of Structures 2, 2-1, 2-2, and 2-3, t is not zero. In additional embodiments, t is not zero and at least one of L₁, L₃ or L₄ is other than a single bond. In additional embodiments, t is not zero and L₁ is other than a single bond. In embodiments, t is not zero and L₁ is other than a single bond and L₂ is a single bond. In additional embodiments, t is not zero and L₃ is other than a single bond. In additional embodiments, t is not zero and L₄ is other than a single bond. In additional embodiments, t is not zero and L₃ and L₄ are other than a single bond. In additional embodiments, t is not zero and each of L₁, L₃ and L₄ is other than a single bond. In additional embodiments, t is not zero and each of L₁, L₃ and L₄ is other than a single bond and L₂ is a single bond. In additional embodiments, t is not zero, L₁ is other than a single bond and each of L₃ and L₄ is a single bond. In additional embodiments, t is not zero, L₁ is a single bond and either or both of L₃ and L₄ are other than a single bond. In additional embodiments, any one of L₁, L₃ or L₄ is —O—CO—. In additional embodiments, any two of L₁, L₃ or L₄ are —O—CO—. In embodiments, each of L₁, L₃ and L₄ is —O—CO—. In additional embodiments, n is not zero, L₁ is other than a single bond, L₂ is a single bond, and each of L₃ and L₄ is a single bond. In additional embodiments, t is not zero, L₁ is a single bond, L₂ is a single bond and either or both of L₃ and L₄ are other than a single bond. In additional embodiments, any one of L₁, L₃ or L₄ is —O—CO— and L₂ is a single bond. In additional embodiments, any two of L₁, L₃ or L₄ are —O—CO— and L₂ is a single bond. In additional embodiments, each of L₁, L₃ and L₄ is —O—CO— and L₂ is a single bond. In additional embodiments, L₁ is a single bond and L₂ is —O—CO—.

In additional embodiments, L₁ is a single bond, L₂ is —O—CO— and L₃ and L₄ are both single bonds. In additional embodiments, L₁ is —O—CO—, L₂ is a single bond and L₃ and L₄ are both single bonds. In additional embodiments, L₁ is —O—CO— and each of L₂, L₃ and L₄ are single bonds. In additional embodiments, L₁ is a single bond, L₂ is —O—CO— and each of L₃ and L are other than single bonds. In additional embodiments, L₁ is a single bond, L₂ is —O—CO— and each of L₃ and L₄ are other than single bonds. In additional embodiments, each of L₁ and L₂ is a single bond (L₁ and L₂ together are a single bond) and each of L₃ and L₄ are other than a single bond.

In embodiments of Structures 2, 2-1, 2-2, 2-3, the repeating units containing T and D are randomly arranged in the copolymer. In embodiments of Structures 2, 2-1, 2-2, 2-3, the repeating units containing T and D are arranged in blocks in the copolymer. In embodiments, T containing repeating unit blocks range in size from 2 to t, 10 to t, 100 to t, 500 to t, or 1,000 to t. In embodiments, D containing repeating unit blocks range in size from 2 to d, 10 to d, 100 to d, 0.500 to t or 1,000 to t.

In embodiments, T and D containing repeating unit blocks range in size from 2 to t or 2 to d, respectively. In embodiments, T and D containing repeating unit blocks range in size from 10 to t or 10 to d, respectively. In embodiments, T and D containing repeating unit blocks range in size from 100 to t or 100 to d, respectively. In embodiments, T and D containing repeating unit blocks range in size from 1000 to t or 1000 to d, respectively.

In embodiments of Structures 2, 2-1, 2-2, 2-3, 2-4 and 2-5, the divalent organic radical of L₁-L₄ is selected from an optionally substituted linear or branched divalent alkyl radical, an optionally substituted divalent aromatic radical, an optionally substituted divalent heteroaromatic aromatic radical, an optionally substituted divalent oligomeric radical, or an optionally substituted divalent polymeric radical. In additional embodiments, the divalent organic radical is —(CH₂)ₐ—, where a is an integer ranging from 1-20 (or 1-12, 1-10, 1-8, or 1-6, or is 1, 2 or 3). In additional embodiments, the divalent organic radical is —(CH₂)ₐ—O—(CH₂)_{b}—, where a and b, independently range from 1-20 (or 1-12, 1-10, 1-8, 1-6 or 1-3, or are each independently 1, 2 or 3). In additional embodiments, the divalent organic radical is an optionally substituted phenylene, particularly an optionally substituted 1, 4-phenylene.

In further embodiments, the invention provides copolymers having Structure 3:

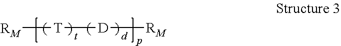

where variables are as defined in the various embodiments of Structure 1, 2, 2-1, 2-2, 2-3, 2-4, 2-5 and 2-6. In embodiments, D is the divalent organic radical obtained from polymerization of optionally substituted DHDO, unsubstituted DHDO, a mixture of two or more optionally substituted glycolaldehyde dimers, or a mixture of two or more of the glycolaldehyde dimers of Scheme 1.

In embodiments of Structure 3, t+d ranges from 2-10, 2-100, 2-200, 2-500 or 2-1000. In embodiments of Structure 3, p ranges from 1-10, 1-50, 1-100, 1-1,000, or 1-10,000. In embodiments, (t+d)p is greater than 10, or is greater than 20 or is greater than 50 or is greater than 100, but is less than 100,000 or less than 1 million.

In embodiments, the invention provides copolymers of Structure 3-1, which are, for example, prepared by polymerization of optionally substituted 2,5-dihydroxy-1,4-dioxane or a prepolymer of optionally substituted 2,5-dihydroxy-1,4-dioxane with a second monomer:

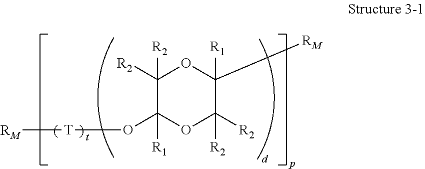

where variables are defined in the various embodiments of Structures 1, 1-2, 2, 2-1, 2-2, 2-3, 2-4, 2-5, 2-6 and 3 above.

In additional embodiments, copolymers of Structure 3-1 include those of Structures 3-2 or 3-3:

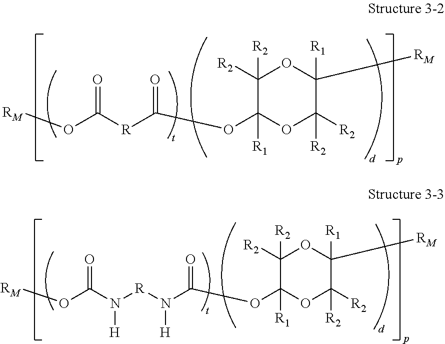

where:
t and d independently are integers ranging from 1 to 1 million or 2-1 million;
p is an integer ranging from 1 to 100 million or more specifically from 2 to 100 million; each of R₁, R₂ and R_{M} is independently as defined for various embodiments of Structures 1, 1-2, 2, 2-1, 2-2, 2-3, 2-4, 2-5, 2-6, and 3; and
—R— is divalent (bivalent) and is selected from a single bond, —O—, —NH—, —NR₁₀—, —S—, —SO—, —SO₂—, —PR₁₀—, —O—PO(OR₁₀)—O—, and an optionally substituted linear or branched divalent organic radical, where R₁₀ is a monovalent organic radical.

In embodiments of Structures 3, 3-1 or 3-2, the ratio of t/d ranges from 0.01 to 100. In additional embodiments, the ration of t/d ranges from 0.1 to 10. In embodiments, the ratio of t/d ranges from 0.2 to 5. In embodiments, the ratio of t/d ranges from 0.5 to 2. In embodiments, the ratio of t/d is 1+/−10%.

In embodiments of Structures 3, 3-1 or 3-2, the repeating units containing T and D are randomly arranged in the copolymer. In embodiments of Structures 2, 2-1, 2-2, 2-3, the repeating units containing T and D are arranged in blocks in the copolymer. In embodiments, T containing repeating unit blocks range in size from 2 to t, 10 to t, 100 to t, 500 to t, or 1,000 to t. In embodiments, D containing repeating unit blocks range in size from 2 to d, 10 to d, 100 to d, 0.500 to t or 1,000 to t.

In embodiments, T and D containing repeating unit blocks range in size from 2 to t or 2 to d, respectively. In embodiments, T and D containing repeating unit blocks range in size from 10 to t or 10 to d, respectively. In embodiments, T and D containing repeating unit blocks range in size from 100 to t or 100 to d, respectively. In embodiments, T and D containing repeating unit blocks range in size from 1000 to t or 1000 to d, respectively.

In embodiments, R₁₀ is an optionally substituted alkyl, alkenyl, or aryl group. In embodiments, optional substitution of R and R₁₀ include substitution with one or more halogen, alkyl, alkenyl, aryl or alkoxy, and particularly alkyl or alkoxy groups having 1-3 carbon atoms, alkenyl groups having 2-3 carbon atoms, or an optionally substituted phenyl or an optionally substituted benzyl group, where in embodiments optional substitution is substitution with one or more halogens or one or more alkyl or alkoxy groups having 1-3 carbon atoms.

In embodiments, the divalent organic radical of —R— is selected from an optionally substituted linear or branched divalent alkyl radical, an optionally substituted divalent aromatic radical, an optionally substituted divalent heteroaromatic aromatic radical, an optionally substituted divalent oligomeric radical, or an optionally substituted divalent polymeric radical. In embodiments, the divalent organic radical is —(CH₂)ₐ—, where a is an integer ranging from 1-20 (or 1-10, or 1-6, or is 1, 2 or 3). In embodiments, the divalent organic radical is —(CH₂)ₐ—O—(CH₂)_{b}—, where a and b, independently range from 1-20 (or 1-10, or 1-6, or are each independently 1, 2 or 3). In embodiments, the divalent organic radical is an optionally substituted phenylene, particularly an optionally substituted 1, 4-pheylene. In embodiments, —R— is an optionally substituted divalent aryl, or optionally substituted divalent heteroaryl, including among others divalent phenyl (phenylene), divalent methylphenyl (methylphenylene), divalent dimethyl phenyl (dimethylphenylene), divalent naphthylene (naphthalene-diyl), divalent furfuryl (furanylene), or divalent pyridyl (pyridinylene).

In specific embodiments of Structures 3-2 and 3-3, R is —(CH₂)ₐ—, where a is 1, 2 or 3 and each R₁ or R₂ is hydrogen. In specific embodiments of Structures 3-2 and 3-3, R is —(CH₂)ₐ—, where a is 1, 2 or 3, each R₁ or R₂ is hydrogen and each R_{M} independently is hydrogen, hydroxyl, linear or branched alkyl, methyl, ethyl, propyl, butyl, alkoxy, methoxy, ethoxy, propanoxy, acyl, acyloxy, acetyl, acetoxy, amino, alkylamino, aryl, alkyl aryl, an acrylate group, or a methacrylate.

In embodiments of Structures 3, 3-1, 3-2, and 3-3, d is 1-1 million and t is 1-10 million or t is 1-1000, or t is 1-100 or t is 10 to 100. In embodiments further embodiments, d is 1-1000 and t is 1-10 million or t is 1-1000, or t is 1-100 or t is 10 to 100. In embodiments, p is 2 to 100,00 or 2-50,000, or 2-10,000 or 2 to 1000, or 10 to 100.

In embodiments of Structures 3, 3-1, 3-2 and 3-3, each of R₁ and R₂ is independently hydrogen, or alkyl having 1-3 carbon atoms. In embodiments of Structures 3, 3-1, 3-2 and 3-3, each R_{M} is independently hydrogen or acyl and in particular is acetyl. In embodiments, each R_{M} is hydrogen, phenyl, benzyl or benzoyl.

In embodiments of Structures 3, 3-1, 3-2 and 3-3, —R— is (CH₂)ₐ with a =1,2,4,6,8,10,12; or a bivalent radical of benzene, naphthalene, furan, pyridine, pyrrole, cyclohexane, tertrahydrofuran, indole, thiofuran, benzofuran or cyclopentane each of which is optionally substituted.

In embodiments of Structure 3-3, the second monomer is a di- tri- or poly-isocyanate. Diisocyanates include among others methylenebis(phenyl isocyanate) (MDI), toluene diisocyanate (TDI), and hexamethylene diisocyanate (HDI), naphthalene diisocyanate (NDI), methylene bis-cyclohexylisocyanate (HMDI)(hydrogenated MDI), and isophorone diisocyanate (IPDI), Tetramethylxylidene diisocyanate (TMXDI), their isomers, dimers, trimers, biuret and isocianutare derivatives.

In embodiments of any structures herein, the second monomer (T) is selected from those of structures of T5-T13.

In embodiments, T is the divalent repeating unit of structure T3 or T4:

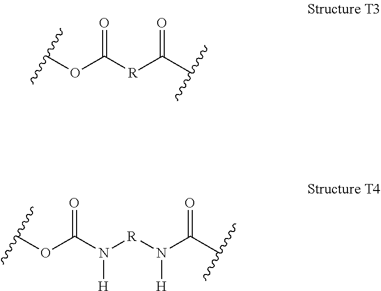

where —R— is divalent (bivalent) and is selected from a single bond, —O—, —NH—, —NR₁₀—, —S—, —SO—, —SO₂—, —PR₁₀—, —O—PO(OR₁₀)—O—, and an optionally substituted linear or branched divalent organic radical, where R₁₀ is a monovalent organic radical. In embodiments, R₁₀ is an optionally substituted alkyl, alkenyl, or aryl group. In embodiments, optional substitution of R and R₁₀ include substitution with one or more halogen, alkyl, alkenyl, aryl or alkoxy, and particularly alkyl or alkoxy groups having 1-3 carbon atoms, alkenyl groups having 2-3 carbon atoms, or an optionally substituted phenyl or an optionally substituted benzyl group, where in embodiments optional substitution is substitution with one or more halogens or one or more alkyl or alkoxy groups having 1-3 carbon atoms.

In embodiments, the divalent organic radical of —R— is selected from an optionally substituted linear or branched divalent alkyl radical, an optionally substituted divalent aromatic radical, an optionally substituted divalent heteroaromatic aromatic radical, an optionally substituted divalent oligomeric radical, or an optionally substituted divalent polymeric radical. In embodiments, the divalent organic radical is —(CH₂)ₐ—, where a is an integer ranging from 1-20 (or 1-10, or 1-6, or is 1, 2 or 3). In embodiments, the divalent organic radical is —(CH₂)ₐ—O—(CH₂)_{b}—, where a and b, independently range from 1-20 (or 1-10, or 1-6, or are each independently 1, 2 or 3). In embodiments, the divalent organic radical is an optionally substituted phenylene, particularly an optionally substituted 1, 4-pheylene. In embodiments, —R— is an optionally substituted divalent aryl, or optionally substituted divalent heteroaryl, including among others divalent phenyl, divalent methylphenyl, divalent dimethyl phenyl, divalent naphthyl, divalent furfuryl, or divalent pyridyl.

In embodiments, optional substitution of R and R₁₀ includes substitution with one or more halogen, alkyl, alkenyl, aryl or alkoxy, and particularly alkyl or alkoxy groups having 1-3 carbon atoms, alkenyl groups having 2-3 carbon atoms, or an optionally substituted phenyl or an optionally substituted benzyl group, where in embodiments optional substitution is substitution with one or more halogens or one or more alkyl or alkoxy groups having 1-3 carbon atoms.

In embodiments, the second monomer (which forms the T repeating unit) is formed by reaction of an alkyl diacid, an ester thereof, or an anhydride thereof, or a diacid halide, particularly a diacid chloride thereof. In embodiments, the alkyl diacid or diester monomer has formula T5, T6 or T7. In embodiments, the diacyl halide monomer has formula T8, T9 or T10. In embodiments, the diisocyanate monomer has formula T11, T12 or T13. In embodiments, the second monomer is an isomer, dimer, trimer, biuret or isocyanurate derivative of formula T11, T12 or T13.

The structures of T5-T13 ar:

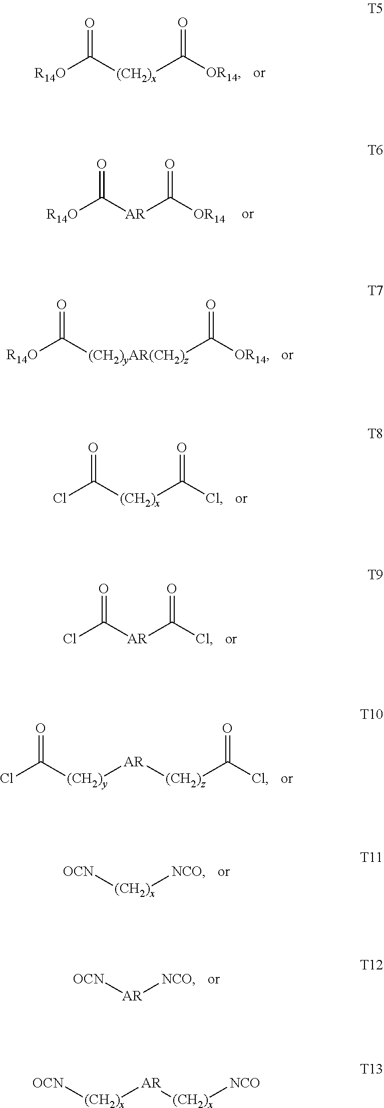

where:
each R₁₄ is independently hydrogen, deuterium, an alkyl group, or an aryl group;
in T5, T8, T11, x is an integer ranging from 1-100 (more specifically x is 1-20, x is 1-12, x is 1-8, x is 1-6, x is 1-3 or x is 1, 2 or 3) and
one or more of the CH₂ groups is optionally substituted;
in T6, T7, T9, T10, T12 and T13, AR is an optionally substituted divalent aryl, or optionally substituted divalent heteroaryl, including among others divalent phenyl, divalent methylphenyl, divalent dimethyl phenyl, divalent naphthyl or divalent furfuryl, or divalent pyridyl;
in T7, T10 and T13, y and z are 0 or an integer from 1-6, where at least one of y or z is not zero.

Optional substitution in T5-T13 is substitution with one or more groups selected from deuterium, halide, optionally protected hydroxyl group (—OH, —OPR₉), an amino group (—NH₂), an alkylamino group (—NHR₉), a (dialkylamino) group [—N(R₉)₂], an alkyl group, an alkenyl group, an alkynyl group, an alkoxy group, an alkoxyalkyl group, an alkoxyalkenyl group, an alkoxyalkynyl group, a haloalkyl group, a haloalkenyl group, a haloalkynyl group, a haloalkoxy group, an aryl group, an alkoxyaryl group, a haloaryl group, an alkylaryl group, an alkyl carbonate group, a thiol group (—SH), alkylthio (—SR₉), a nitro group (—NO₂), a cyano group (—C≡N), a isocyanate group (—N═C═O), an azide group (—N₃), a cyanate group (—O═C═N), a nitroso group (—NO), a phosphine group [—P(R₉)₂], a phosphate group [—OP(O)(OR₉)₂], a phosphonate group [—P(O)(OR₉)₂], a sulfate group (—O—SO₃R₉), a sulfonate group (—SO₃R₉), a thiocyanate group (—S═C═N), a isothiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N═C(R₉)₂, and a —CR₉═NR₉, where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group.

In another embodiment, the second monomer is a di- tri- or poly-isocyanate. Diisocyanates include among others methylenebis(phenyl isocyanate) (MDI), toluene diisocyanate (TDI), and hexamethylene diisocyanate (HDI), naphthalene diisocyanate (NDI), methylene bis-cyclohexylisocyanate (HMDI)(hydrogenated MDI), and isophorone diisocyanate (IPDI), Tetramethylxylidene diisocyanate (TMXDI), their isomers, dimers, trimers, biuret and isocyanurate derivatives.

In yet another embodiment, the second monomer is a reagent that will form a carbonate group upon reaction, including but not limited to, phosgene, urea, urea derivatives, a dialkyl carbonate and more specifically dimethyl carbonate, an alkylene carbonate, diphosgene, triphosgene, carbonyl diimidazole, disuccinimidyl carbonate, or carbon monoxide.

In embodiments, the polymerization of succinic acid or its dimethyl esters and 2,5-dihydroxy-1,4-dioxane leads to a polyester-co-polyacetal where t, d and p are as defined in the various embodiments of Structures 2 and 3:

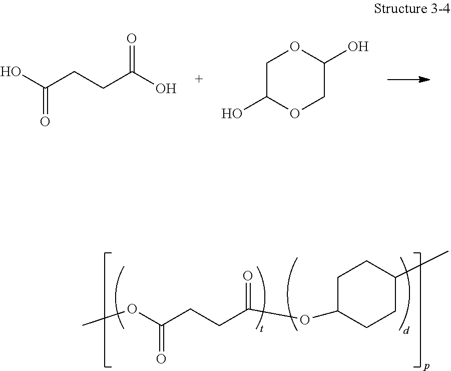

In embodiments, the polymerization of succinyl chloride and 2,5-dihydroxy-1,4-dioxane also leads to a polyester-co-polyacetal where t, d and p are as defined in the various embodiments of Structures 2 and 3:

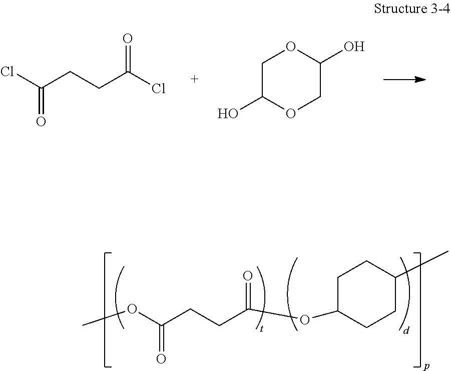

In specific embodiments of Structure 3-4, t and d are both =1. In embodiments, t and d are both 1 and p is 2 to 10 million or p is 2 to 1 million. In embodiments, t is 1 and d is 2-10 million or d is 2-1 million. In specific embodiments of Structure 3-4, t and d both =1 and p is greater than 10. In embodiments of structure 3-4, t=1 and d is 2-100,000 and p is greater than 10.

Note that in the above reactions with succinic acid/ester or acid chloride, unsubstituted -DHDO- (as shown) can be replaced with optionally substituted -DHDO- or a mixture of two or more optionally substituted glycolaldehyde dimers (-MDHDO-).

In embodiments, the reaction of a diisocyanate and 2,5-dihydroxy-1,4-dioxane leads to a polyurethane where t, d and p are defined as in the various embodiments of Structures 2 and 3:

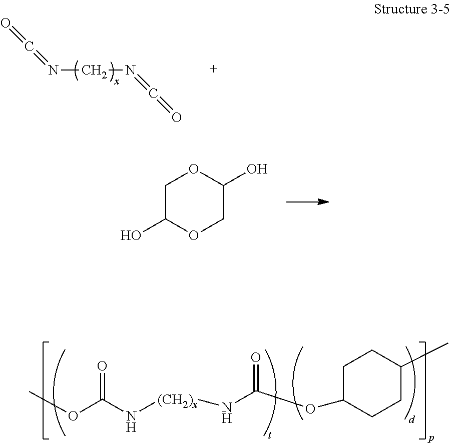

where x is an integer and preferably ranges from 1-12, or 1-8, or 1-6, or 1-3 or is 1, 2 or 3. In embodiments, t and d both =1 and p is 10 or greater. In embodiments of structure 3-4, t=1 and d is 2-100,000 and p is greater than 10.

Note that in the above reactions with diisocyanate, unsubstituted -DHDO- (as shown) can be replaced with optionally substituted -DHDO- or a mixture of two or more optionally substituted glycolaldehyde dimers (-MDHDO-).

In embodiments, copolymers of the invention comprise the repeated units of Structures 3-4, and 3-5, where the copolymer end groups R_{M} can independently take any value of R_{M} as defined in Structures 1, 2 or 3. In embodiments of such copolymers, R_{M} is independently hydrogen, hydroxyl, acrylate or methacrylate.

In embodiments of Structures 3-4 and 3-5, the ratio of t/d ranges from 0.01 to 100. In additional embodiments, the ration of t/d ranges from 0.1 to 10. In embodiments, the ratio of t/d ranges from 0.2 to 5. In embodiments, the ratio of t/d ranges from 0.5 to 2. In embodiments, the ratio of t/d is 1+/−10%.

In embodiments of Structures 3-4 and 3-5, the repeating units containing T and D are randomly arranged in the copolymer. In embodiments of Structures 2, 2-1, 2-2, 2-3, the repeating units containing T and D are arranged in blocks in the copolymer. In embodiments, T containing repeating unit blocks range in size from 2 to t, 10 to t, 100 to t, 500 to t, or 1,000 to t. In embodiments, D containing repeating unit blocks range in size from 2 to d, 10 to d, 100 to d, 500 to d or 1,000 to d.

In embodiments, T and D containing repeating unit blocks range in size from 2 to t or 2 to d, respectively. In embodiments, T and D containing repeating unit blocks range in size from 10 to t or 10 to d, respectively. In embodiments, T and D containing repeating unit blocks range in size from 100 to t or 100 to d, respectively. In embodiments, T and D containing repeating unit blocks range in size from 1000 to t or 1000 to d, respectively.

Non-limiting examples of the comonomer (second monomer that forms repeating unit T) that can be used to make the copolymer compositions in structures herein include those shown in Table 1 below and their acid halides, acid chloride, anhydrides, methyl esters, ethyl esters and alkyl ester derivatives.

TABLE 1
Exemplary Second Monomers

| Second Monomer | Structure |
|---|---|
| Furan-2,5- dicarboxylic acid | 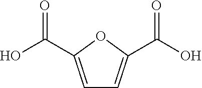 [SMILES: O=C(O)c1ccc(C(=O)O)o1] |
| Terephthalic acid | 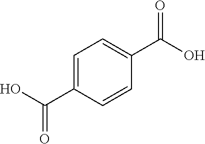 [SMILES: O=C(O)c1ccc(C(=O)O)cc1] |
| Isophthalic acid | 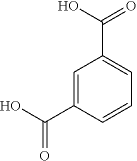 [SMILES: O=C(O)c1cccc(C(=O)O)c1] |
| Phthalic acid | 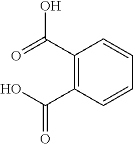 [SMILES: O=C(O)c1ccccc1C(=O)O] |
| 2,6- Naphthalenedicarboxylic acid | 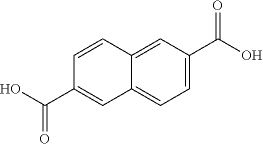 [SMILES: O=C(O)c1ccc2cc(C(=O)O)ccc2c1] |
| 2,6- Pyridinedicarboxylic acid | 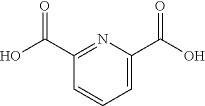 [SMILES: O=C(O)c1cccc(C(=O)O)n1] |
| 2,5- Pyridinedicarboxylic acid | 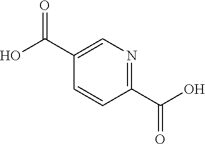 [SMILES: O=C(O)c1ccc(C(=O)O)nc1] |
| 3,5- Pyridinedicarboxylic acid | 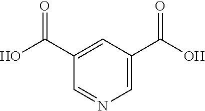 [SMILES: O=C(O)c1cncc(C(=O)O)c1] |
| Oxalic acid | 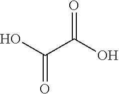 |
| Malonic acid | 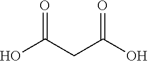 |
| Succinic acid | 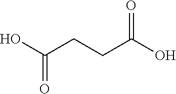 |
| Glutaric acid | 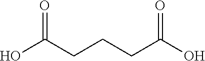 |
| Adipic acid | 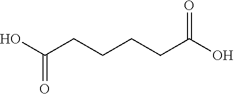 |
| Diisocyanate | 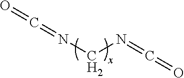 |

The second monomers listed in Table 1 and their acid halides, acid chloride, anhydrides, methyl esters, ethyl esters and alkyl ester derivatives can be optionally substituted. For example, one or more hydrogens in these species can be substituted with one or more groups as defined in Structure 1 for R₁-R₃. In embodiments, optional substitution includes substitution with one or more halogen, one or more alkyl, one or more alkoxy, one or more phenyl or benzyl, one or more phenoxy or benzyloxy. Alkyl and alkoxy substituents include those having 1-3 carbon atoms.

Other embodiments of this invention include copolymers including two or more optionally substituted glycolaldehyde dimers of Structure 4:

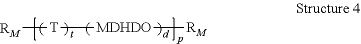

where variables T and R_{M} are as defined in various embodiments of Structures 1, 1-2, 2, 2-1, 2-2, 2-3, 2-4, 2-5, 3, 3-1, 3-2, 3-3, 3-4, or 3-5, t, d and p are as defined in various embodiments of Structures 2 and 3 and -MDHDO- represents a combination of two or more optionally substituted glycolaldehyde dimers as illustrated in Structure A:

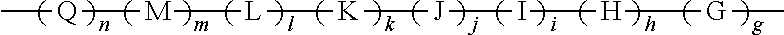

where at least two of n, m, l, k, j, i, h or g are not zero and where the integers n, m, l, k, j, i, h, and g are as defined in various embodiment of Structure 1.

In embodiments, the invention provides copolymers of structures 4-1 and 4-2:

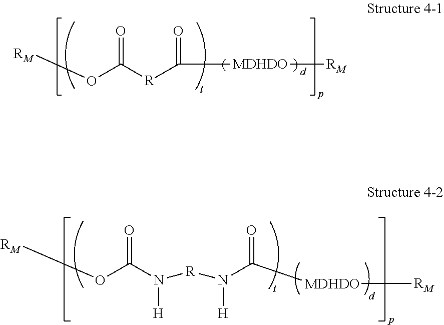

where variables take values as defined in any embodiments of Structures 1, 1-2, 2, 2-1, 2-2, 2-3, 2-4, 2-5, 3, 3-1, 3-2, 3-3, 3-4, 3-5, 4, or 4-1. In embodiments, t and d=1 and p is 10 or greater. In embodiments, R is —(CH₂)ₐ—, where a is 1-12, 1-10, 1-8, 1-6, or 1-3 or is 1, 2 or 3. In embodiments, each R_{M} independently is hydrogen, hydroxyl, acyl, acrylate or methacrylate.

In embodiments, in the structure of -MDHDO- above (Structure A), at least one of n, m or l is non-zero. In additional embodiments, n, m and l are non-zero and each of k, j, l, h and g is zero.

In embodiments, in the structure of -MDHDO-, each of R₁ and R₂ of O, M, L, K, J, I, H and G is hydrogen and each R_{M} independently is hydrogen, acyl, or alkyl. In embodiments, each of R₁ and R₂ of Q, M, L, K, J, I, H and G is hydrogen or methyl or phenyl and each R_{M} independently is hydrogen, acyl, or alkyl.

In embodiments, —R— is as defined in all embodiments of Structures 2, 3 or 4. In embodiments, —R— is a divalent organic radical.

In certain embodiments, copolymers of this invention have structures wherein n>m+l.

In embodiments of structures herein, n/(n+m+l) ranges from 0.1 to 0.9999. In embodiments of structures herein, n/(n+m+l) ranges from 0.5 to 0.999. In embodiments of structures herein, n/(n+m=l) ranges from 0.95 to 0.999.

In embodiments, the invention also provides polymer compositions comprising, consisting essentially of or consisting of one or more copolymers of any structure herein.

In embodiments of Structures 4, 4-1 and 4-2, the ratio of t/d ranges from 0.01 to 100. In additional embodiments, the ration of t/d ranges from 0.1 to 10. In embodiments, the ratio of t/d ranges from 0.2 to 5. In embodiments, the ratio of t/d ranges from 0.5 to 2. In embodiments, the ratio of t/d is 1+/−10%.

In embodiments of Structures 4, 4-1 and 4-2, the repeating units containing T and D are randomly arranged in the copolymer. In embodiments of Structures 2, 2-1, 2-2, 2-3, the repeating units containing T and D are arranged in blocks in the copolymer. In embodiments, T containing repeating unit blocks range in size from 2 to t, 10 to t, 100 to t, 500 to t, or 1,000 to t. In embodiments, D containing repeating unit blocks range in size from 2 to d, 10 to d, 100 to d, 0.500 to t or 1,000 to t.

In embodiments, T and D containing repeating unit blocks range in size from 2 to t or 2 to d, respectively. In embodiments, T and D containing repeating unit blocks range in size from 10 to t or 10 to d, respectively. In embodiments, T and D containing repeating unit blocks range in size from 100 to t or 100 to d, respectively. In embodiments, T and D containing repeating unit blocks range in size from 1000 to t or 1000 to d, respectively.

Copolymers of this invention also include those of Structure 5 as well as polymer compositions comprising, consisting essentially of or consisting of one or more copolymer of structures 5:

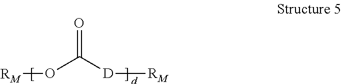

where D is a diradical formed on polymerization of an optionally substituted glycolaldehyde dimer, and d is the integer number of repeats in the polymer and can range from 2 to 1 million or is 11-1 million, or is 20-1 million, or is 100-1 million, or is 1,000 to 1 million, or is 10,000 to 1 million, or 100,000 to 1 million. In embodiments, d is 11 or more, or 20 or more or 50 or more or 100 or more and R_{M} takes values as defined in any embodiments of any other structure herein. In embodiments, D is the diradical formed on polymerization of optionally substituted DHDO, unsubstituted DHDO, or MDHDO (as defined in Structure A) or of a mixture of two or more of the glycolaldehyde dimers of Scheme 1.

Copolymers of the invention also include those of Structure 5-1:

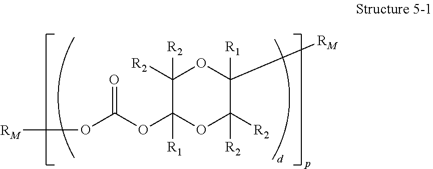

where variables are defined as in various embodiments of Structures 1, 1-2, 2, 2-1, 2-2, 2-3, 2-4, 2-5, 3, 3-1, 3-2, 3-3, 3-4, 3-5, 4, 4-1, 4-2, or 5. In embodiments, R₁ and R₂ are hydrogens. In embodiments d is 2 to 10 million or 11 to 10 million or 11 to 1,000, 11 to 10,000 or 11 to 100,000 or 11 to 1 million. In embodiments, R_{M} independently is hydrogen, hydroxyl, acyl, acrylate or methacrylate.

Copolymers of the invention also include those of Structure 5-2:

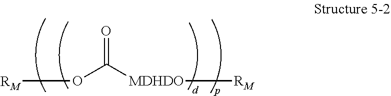

where variables are defined as in various embodiments of Structures 1, 1-2, 2, 2-1, 2-2, 2-3, 2-4, 2-5, 3, 3-1, 3-2, 3-3, 3-4, 3-5, 4, 4-1, 4-2, or 5. -MDHDO- is a diradical formed on polymerization a mixture of optionally substituted glycolaldehyde dimers as illustrated in Structure A. In embodiments, R₁ and R₂ are hydrogens. In embodiments d is 2 to 10 million or 11 to 10 million or 11 to 1,000, 11 to 10,000 or 11 to 100,000 or 11 to 1 million. In embodiments, R_{M} independently is hydrogen, hydroxyl, acyl, acrylate or methacrylate. In embodiments, d is 1 and p ranges from 1 to 10 million. In embodiments, d is 2 and p ranges from 1 to 10 million.

Copolymers of this invention also include those of Structure 6 as well as polymer compositions comprising, consisting essentially of or consisting of one or more copolymer of structures 6:

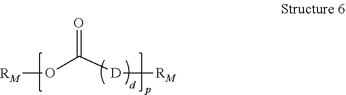

where D is a diradical formed on polymerization of an optionally substituted glycolaldehyde dimer, and d is the integer number of repeats in the polymer and can range from 2 to 1 million or is 11-1 million, or is 20-1 million, or is 100-1 million, or is 1,000 to 1 million, or is 10,000 to 1 million, or 100,000 to 1 million.

In embodiments, d is 11 or more, or 20 or more or 50 or more or 100 or more and R_{M} takes values as defined in any embodiments of any other structure herein. In embodiments, D is the diradical formed on polymerization of optionally substituted DHDO, unsubstituted DHDO, or MDHDO (where -MDHDO- is defined in Structure A) or a diradical formed on polymerization of a mixture of two or more of the glycolaldehyde dimers of Scheme 1.

Copolymers of the invention also include those of Structure 6-1:

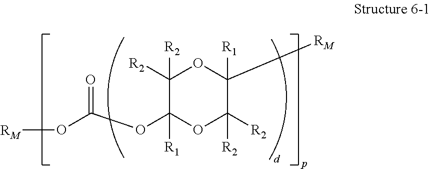

where each R₁, R₂ and R_{M} are independently as defined as in Structures 1, 1-2, 2, 2-1, 2-2, 2-3, 2-4, 2-5, 2-6, 3, 3-1, 3-2, 3-3, 3-4, 3-5, 4, 4-1, 4-2, 5, 5-1 or 5-2 and in all listed embodiments thereof; and d and p are positive integers independently ranging from 1 to 10 million. The integers p and d can take any ranges or values as defined in any of Structures 1, 1-2, 2, 2-1, 2-2, 2-3, 2-4, 2-5, 2-6, 3, 3-1, 3-2, 3-3, 3-4, 3-5, 4, 4-1, 4-2, 5, 5-1, 5-2 or 6. In embodiments, each of R₁ and R₂ is hydrogen and R_{M} is hydrogen, hydroxyl, acyl, acrylate, methacrylate or alkyl.

Copolymers of this invention also include those of structure 6-2 as well as polymer compositions comprising, consisting essentially of or consisting of one or more copolymer of Structure 6-2:

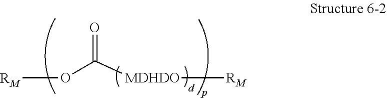

where variables take values as defined in any embodiment of any of Structures 1, 1-2, 2, 2-1, 2-2, 2-3, 2-4, 2-5, 3, 3-1, 3-2, 3-3, 3-4, 3-5, 4, 4-1, 4-2, 5, 5-1, 5-2 or 6 and -MDHDO- is a diradical formed on polymerization of a mixture of two or more optionally substituted glycolaldehyde dimers as illustrated in Structure A.

In embodiments, the diradical glycolaldehyde dimers of -MDHDO- are those of Scheme 1. In embodiments d is 1 to 1 million, or 2 to 1 million, or 1 to 100,000, or 1 to 10,000, or 1-1,000 or 1-500, or 1-100, or 1-50, or 2 to 100,000, 2 to 10,000, or 2 to 1,000 or 2 to 500, or 2-100. In embodiments, d is greater than 11. In embodiments, d×p is 2 to 10 million, or 4 to 10 million or 2 to 1 million or 4 to 1 million or 2 to 100,000 or 4 to 100,000 or 2 to 10,000 or 4 to 10,000 or 2 to 1,000 or 4 to 1,000 or 2 to 500, or 4 to 500, or 2 to 100 or 4 to 100 or 2-50 or 4 to 50. In embodiments, R_{M} is hydrogen, hydroxyl, acyl, acrylate, methacrylate or alkyl.

In embodiments of any structure herein, the ratio of t/d ranges from 0.01 to 100. In additional embodiments, the ration of t/d ranges from 0.1 to 10. In embodiments, the ratio of t/d ranges from 0.2 to 5. In embodiments, the ratio of t/d ranges from 0.5 to 2. In embodiments, the ratio of t/d is 1+/−10%.

In embodiments of any structures herein, the repeating units containing T and D are randomly arranged in the copolymer. In embodiments of Structures 2, 2-1, 2-2, 2-3, the repeating units containing T and D are arranged in blocks in the copolymer. In embodiments, T containing repeating unit blocks range in size from 2 to t, 10 to t, 100 to t, 500 to t, or 1,000 to t. In embodiments, D containing repeating unit blocks range in size from 2 to d, 10 to d, 100 to d, 500 to d or 1,000 to d.

In embodiments of any structures herein, T and D containing repeating unit blocks range in size from 2 to t or 2 to d, respectively. In embodiments, T and D containing repeating unit blocks range in size from 10 to t or 10 to d, respectively. In embodiments, T and D containing repeating unit blocks range in size from 100 to t or 100 to d, respectively. In embodiments, T and D containing repeating unit blocks range in size from 1000 to t or 1000 to d, respectively.

In embodiments of any structure herein, R₃ or R_{M} independently is hydrogen, hydroxyl, linear or branched alkyl, methyl, ethyl, propyl, butyl, alkoxy, methoxy, ethoxy, propyloxy, acyl, acyloxy, acetyl, acetoxy, amino, alkylamino, aryl, alkylaryl, an acrylate group, or a methacrylate.

In embodiments of any structure herein, CH₂ groups are optionally substituted, where optional substitution includes substitution with one or more alkyl, alkoxy, OH group, or halogen. In embodiments, optionally substitution is with one or more alkyl or alkoxy having 1-3 carbon atoms.

In embodiments of any structures herein, alkyl groups in any functional group or substituent include linear, branched or cycloalkyl group can have 1-12 carbon atoms, 1-6 carbon atoms, 1-3 carbon atoms or 1, 2 or 3 carbon atoms. In embodiments of any structure herein, alkyl groups include cycloalkyl groups having 1-3 rings which may be fused and which have 3-8 carbons/ring. In embodiments of any structure herein, cycloalkyl groups include mono-, bi- and tricyclic rings and cycloalkyl groups include those having 3-12, and 3-6 carbon atoms. In embodiments of any structure herein alkyl groups are optionally substituted.

In embodiments of any structure herein, acyl and acyloxy groups have formulas R_{A}—CO— and R_{A}—CO—O—, where R_{A} is an optionally substituted alkyl or an optionally substituted aryl group.

In embodiments of any structure herein, aryl groups include groups having 1 to 3 6-member aromatic rings, which may be fused. In embodiments, aryl groups include phenyl, biphenyl and naphthyl groups.

In embodiments of any structure herein, heterocyclic groups include those having 1-3 or 1-2 rings including 5- and 6-member rings, wherein at least one ring includes at least one heteroatom (e.g., O, S, N or P). Heteroaryl groups are a sub-set of heterocyclic groups in which at least one ring containing a heteroatom is an aromatic ring. Exemplary non-aromatic heterocyclic groups are tetrahydrofuryl, pyrrolidinyl, piperidinyl, morpholinyl and dioxanyl. Exemplary heteroaryl groups are oxiranyl, furyl, pyrroly, thiophenyl, imidazolyl, pyridinyl, indolyl, quinolinyl.

In embodiments, copolymers of this invention comprise 50% or more of monomer units formed from an optionally substituted glycolaldehyde dimer. In embodiments, copolymers prepared by the methods of this invention comprise 60%, 70%, 80%, 90%, 95% or 99% or more of monomer units formed from an optionally substituted glycolaldehyde dimer. In embodiments, the glycolaldehyde dimer is optionally substituted DHDO. In embodiments the glycolaldehyde dimer is unsubstituted DHDO.

In embodiments, polymer and copolymer of any structure herein have weight average molecular weight (Mw) less than 15,000 Da. In embodiments. Mw of these polymers and copolymers ranges from 1,000 Da to less than 15,000 Da. In embodiments. Mw of these polymers and copolymers ranges from 1,000 Da to 10,000 Da. Or from 1,000 Da to 5,000 Da or from 1,000 Da to 2,000 Da, or from 500 Da to 2,000 Da, or from 500 Da to 5,000 Da.

In embodiments, polymer and copolymer of any structure herein have weight average molecular weight (Mw) equal to or greater than 15,000 Da, preferably greater than 15,000 Da (15 kDa), preferably equal to or greater than 20,000 Da, more preferably equal to or greater than 25,000 Da and most preferably equal to or greater than 30,000 Da. In embodiments, the upper limit of Mw of these polymers or copolymers is 50,000 Da, 75,000 Da, 100,000 Da, 500,000 Da or 1,000,000 Da. In embodiments, the Mw of the copolymers of structures herein ranges from 15,000 Da to 100,000 Da, 20,000 Da to 100,000 Da, 25,000 Da to 100,000 Da, or 30,000 Da to 100,000 Da. In embodiments, the Mw of the copolymers of structures herein ranges from 15,000 Da to 50,000 Da, 20,000 Da to 50,000 Da, 25,000 Da to 50,000 Da, or 30,000 Da to 50,000 Da. In embodiments, the Mw of the copolymers of structures herein ranges from 15,000 Da to 40,000 Da, 15,000 Da to 35,000 Da, 15,000 Da to 25,000 Da, or 15,000 Da to 30,000 Da.

In embodiments, polymers and copolymers of this invention have weight average molecular weight (Mw) equal to or greater than 15,000 Da, preferably greater than 15,000 Da (15 kDa), preferably equal to or greater than 20,000 Da, more preferably equal to or greater than 25,000 Da and most preferably equal to or greater than 30,000 Da. In embodiments, the upper limit of Mw of these polymers and copolymers is 50,000 Da, 75,000 Da, 100,000 Da, 500,000 Da or 1,000,000 Da. In embodiments, the Mw of polymers and copolymers herein ranges from 15,000 Da to 100,000 Da, 20,000 Da to 100,000 Da, 25,000 Da to 100,000 Da, or 30,000 Da to 100,000 Da. In embodiments, the Mw of the polymers and copolymers herein ranges from 15,000 Da to 50,000 Da, 20,000 Da to 50,000 Da, 25,000 Da to 50,000 Da, or 30,000 Da to 50,000 Da. In embodiments, the Mw of the polymers and copolymers herein ranges from 15,000 Da to 40,000 Da, 15,000 Da to 35,000 Da, 15,000 Da to 25,000 Da, or 15,000 Da to 30,000 Da.

PDI of synthetic polymers generally varies dependent upon the mechanism of the polymerization reaction and upon the reaction conditions and most often is greater than 1. Most often, PDI ranges up to 20. Uniformity of polymer properties generally increases with decreasing PDI. In embodiments, the polymers and copolymers herein exhibit PDI less than 10 and more preferably less than 5. In specific embodiments, polymers and copolymers herein exhibit PDI of less than 3, less than 2.5 or less than 2.

In embodiments, the reaction between a PDHDO or PMDHDO prepolymer with a second monomer is used to create a copolymer that has different properties from the starting PDHDO or PMDHDO prepolymer including, but not limited to, tensile strength, elasticity, or barrier to oxygen and water. In other embodiments the reaction between a PDHDO or PMDHDO prepolymers with a small amount of a second monomer is used to increase the molecular weight of the starting PDHDO or PMDHDO prepolymer by chain extension.

Polyester copolymers of this invention are prepared by the condensation polymerization of dibasic acids, diesters, diacid halides, or anhydrides with optionally substituted DHDO, unsubstituted DHDO, a mixture of optionally substituted glycolaldehyde dimers (MDHDO), PDHDO or PMDHDO, and mixtures of any thereof. The reaction is carried out either in the solid state or in solution and optionally a catalyst is used. Catalysts include basic compounds such as carbonates, primary secondary and tertiary amines, as well as aluminum alkoxides, or metal compounds and oxides including but not limited to zinc, tin, antimony, and titanium compounds.

Various methods are used to remove the byproduct of the reaction, which may include water, hydrochloric acid, methanol, ethanol or acidic acid. Said method includes running the reaction under reduced pressure, the use of dehydrating reagents, or by using reactors that allows the condensation of water away from the reaction mixture such as a Dean-Stark trap. The reaction is run at a temperature ranging from 0° C. to 280° C., but preferably between 30° C. and 120° C. In embodiments other additives may be added during the polymerization including surfactants, stabilizers, antioxidants, nucleating agents, fillers, pigments and dyes.

Polyurethane copolymers of this invention and related materials including coatings adhesives, foams and sealants are prepared by the reaction of di- tri- and poly-isocyanates with either optionally substituted DHDO, unsubstituted DHDO, a mixture of glycolaldehyde dimers (MDHDO), PDHDO or PMDHDO, and mixture thereof. Polyurethanes copolymers herein may be linear, branched or crosslinked. The polymerization reaction is carried out either by mixing the reagents in their neat liquid or viscous state or in solution and optionally a catalyst is used. Catalysts include metal compounds and amines. Often a metal compound such as an organotin compound is combined with a tertiary amine. Other useful catalysts include guanidines, amidines, N-heterocyclic carbenes, and organic “strong or super-strong” Brønsted acids. In embodiments dibutyltin dilaurate and dibutyltin diacetate catalysts are used. In embodiments the catalyst is selected from the group of 1,4-diazabicyclo[2.2.2]octane (DABCO); 1,5,7-triazabicyclo[4.4.0]dec-5-ene (TBD), N-methyl-1,5,7-triazabicyclododecene (MTBD), and 1,8-diazabicyclo[5.4.0]undec-7-ene (DBU) and 1,3-bis(ditertiobutyl)imidazol-2-ylidene. The reaction is run at a temperature ranging from 0° C. to 280° C., but preferably between 20° C. and 80° C. In embodiments the polymerization process is at or near room temperature.

In embodiments the polymerization process is run in a reactor to produce a plastic product (resin) that is further transformed into the finished good (elastomer, fiber, plastic item) by an extrusion, molding, spinning, or casting method. In other embodiments the polymerization process is run in situ and the product is in the form of a coated good, a cured adhesive, or a blown foam. In embodiments, water or a blowing aged are added during the polymerization to cause the product to foam. In embodiments other additives may be added during the polymerization including surfactants, stabilizers, antioxidants, nucleating agents, fillers, pigments, and dyes.

Polycarbonate copolymers of this invention are prepared by the condensation polymerization of di alkyl carbonates, alkylene carbonate or phosgene, diphosgene, triphosgene, carbonyl diimidazole, disuccinimidyl carbonate, carbon monoxide with either DHDO, a mixture of glycolaldehyde dimers (MDHDO), PDHDO or M-PDHDO, and mixture thereof. The reaction is carried out either in the solid state or in solution and optionally a catalyst is used. Catalysts include basic compounds such as primary secondary and tertiary amines, as well as metals supported on carbon such as palladium, iron, bismuth and copper. In embodiments an organometallic complex of zinc, cobalt, vanadium, or manganese is used. In embodiment the ligand is N,N′-bis(salicylidene)ethylenediamine. Various methods are used to remove the byproduct of the reaction, which may include hydrochloric acid, methanol, ethanol, ethylene glycol or propylene glycol. Said method includes running the reaction under reduced pressure, the use of dehydrating reagents, or by using reactors that allow the condensation of water methanol or other biproducts away from the reaction mixture such as a Dean-Stark trap. The reaction is run at a temperature ranging from 60° C. to 280° C. In embodiments other additives may be added during the polymerization including surfactants, stabilizers, antioxidants, nucleating agents, fillers, pigments and dyes.

Improved methods for polymerization of one or more glycolaldehyde dimers and/or for polymerization of one or more glycolaldehyde dimers in combination with one or more second monomer are provided in U.S. patent application Ser. No. 19/172,571, filed Apr. 7, 2025. This application is incorporated by reference herein in its entirety for such methods of preparation. Methods in this reference are preferred for making polymers and copolymers that exhibit higher molecular weight, specifically polymers and copolymers with weight average molecular weight (Mw) equal to or greater than 15,000 Daltons, and in embodiments, polymers and copolymers that as a consequence of higher molecular weight exhibit improved physical and mechanical properties. In embodiments, the improved methods of this invention deliver polymers and copolymers where the yield of polymerization is improved and preferably the polymerization yield is 50% or higher.

In embodiments, the invention provides a polymer comprising two or more glycolaldehyde dimers selected from the group of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 1,2-dihydroxyethoxyacetaldehyde; (1,3-dioxetane-2,4-diyl)dimethanol; and 2,2′-oxydiacetaldehyde. In embodiments, the invention provides a polymer comprising two or more glycolaldehyde dimers selected from the group of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde.

In embodiments, the invention provides a method of making the recited polymers by polymerization of a mixture comprising two or more glycolaldehyde dimers in the presence of one or more Lewis acid catalysts

In embodiments, the invention provides products which may be polymeric or prepolymeric.

In embodiments, the invention provides a polymer comprising one or more glycolaldehyde dimer selected from the group of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 1,2-dihydroxyethoxyacetaldehyde; (1,3-dioxetane-2,4-diyl)dimethanol; 2,2′-oxydiacetaldehyde and a second monomer. In embodiments, the invention provides a polymer comprising one or more glycolaldehyde dimer selected from the group 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde.

In embodiments, the second monomer is selected from the group of glycolaldehyde, glycolaldehyde dimer, hydroxyaldehydes, carbohydrates, polysaccharides, diols, polyols, compounds containing two or more carboxylic acid groups, hydroxyacids, aminoacids, compounds containing two or more carboxylic acid ester groups, compounds containing two or more acyl chloride groups, compounds containing two or more acyl bromide groups, compounds containing two or more isocyanate groups, compounds containing two or more oxirane groups, compounds containing two or more isothiocyanate groups, compounds containing two or more nitrile groups, compounds containing two or more azide groups, phosgene, dialkyl carbonates, dialkyl dichlorosilanes, and diaryidichlorosilanes.

In embodiments, the invention provides a polymer obtained by reaction of one or more glycolaldehyde dimer selected from the group of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde and a second monomer selected from the group of glycolaldehyde, glycolaldehyde dimer, hydroxyaldehydes, carbohydrates, polysaccharides, diols, polyols, compounds containing two or more carboxylic acid groups, hydroxyacids, aminoacids, compounds containing two or more carboxylic acid ester groups, compounds containing two or more acyl chloride groups, compounds containing two or more acyl bromide groups, compounds containing two or more isocyanate groups, compounds containing two or more oxirane groups, compounds containing two or more isothiocyanate groups, compounds containing two or more nitrile groups, compounds containing two or more azide groups, phosgene, dialkyl carbonates, dialkyl dichlorosilanes, and diaryldichlorosilanes.

In a first aspect, the invention provides a polymer that comprises two or more structurally different glycolaldehyde dimers as monomer units wherein the dimers are selected from the group consisting of 2,5-dihydroxy-1,4-dioxane; (1,2-dihydroxyethoxy)acetaldehyde; 2-(hydroxymethyl)-1,3-dioxolan-4-ol; 1,1′-oxydi(ethane-1,2-diol); 2,2′-oxydi(ethane-1,1-diol); (1,3-dioxetane-2,4-diyl)dimethanol; and 2,2′-oxydiacetaldehyde. In an embodiment, the polymer of the first aspect has from 0.1% to 25% by weight of glycolaldehyde dimers other than 2,5-dihydroxy-1,4-dioxane. In an embodiment of the first aspect, the polymer has Structure 1:

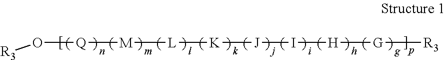

where:

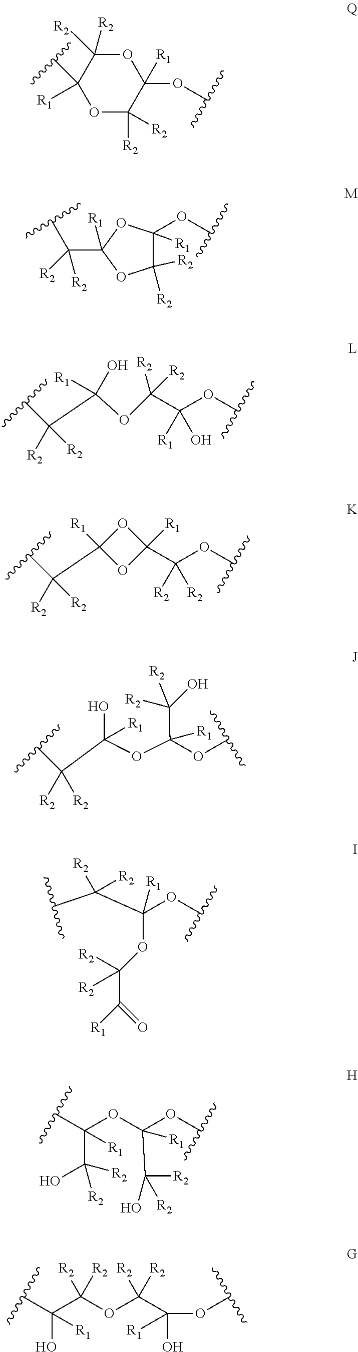

where Q, M, L, K, J, I, H and G are divalent glycolaldehyde dimer species as illustrated and g, h, i, j, k, l, m and n are integers from zero to 10 million, wherein at least two of g, h, i, j, k, l, m and n are different from zero and p is an integer ranging from 1-10 million; and each R₁, R₂ and R₃ 4.is independently selected from the group consisting of hydrogen (—H), deuterium (-D), an halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C≡N), a isocyanate group (—N═C═), a azide group (—N₃), a cyanate group (—O═C═N), a nitroso group (—NO), a phosphine group [—P(R₉)₂], a phosphate group [—OP(O)(OR₉)₂], a phosphonate group [—P(O)(OR₉)₂], a sulfate group (—O—SO₃R₉), a sulfonate group (—SO₃R₉), a thiocyanate group (—S═C═N), a iso thiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N—C(R₉)₂, and a —CR₉═NR₉; where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group; and
each R₁, R₂ and R₃ is independently optionally oligomeric, pre-polymeric or polymeric in nature and selected from the group consisting of end-capped or uncapped polyethers, poly(fluoroethers), polyglycols, polyacetals, polyolefins, polystyrene, polyfluoroolefins, polyoxides, polychlorolefins, polychlorofluoroolefins, polysiloxanes, polyesters, polybromoesters, natural and synthetic rubbers, polyols, polyalcohols, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitriles, polybutadiene, alkyds, polyurethanes, epoxies, cellulose and its derivatives, starch and its derivatives, polypeptides, and copolymers thereof.

In embodiments of the first aspect, each R₁ and each R₂ are independently selected from hydrogen, deuterium, optionally substituted alkyl groups having 1-3 carbon atoms, optionally substituted aryl groups, and optionally substituted phenyl or benzyl groups. In embodiments of the first aspect, each R₃ independently is hydrogen, deuterium, alkyl, alkoxy, acyl, acrylate, methacrylate, aminoalkylene, (alkylamino)alkylene, (bisalkylamino)alkylene, or glycidyl. In further embodiments, R₃ is hydrogen, deuterium, alkyl, alkoxy, or acyl. In embodiments of the first aspect, each R₁ and each R₂ are hydrogen. In further embodiments, R₃ is hydrogen, deuterium, alkyl, alkoxy, or acyl and each R₁ and each R₂ are hydrogen.

In embodiments of Structure 1 of the first aspect, (n+m+l)×p ranges from 10 to 200,000 or (n+m+l+k+j+i+h+g)×p ranges from 2 to 200,000.

In a second aspect, the invention provides a polymer or copolymer of Structure 2:

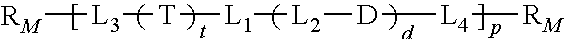

where:
D is a divalent organic radical formed on polymerization of an optionally substituted glycolaldehyde dimer;
d is a positive integer representing the number of D repeating units;
T is a divalent radical formed on polymerization of a second monomer which is other than an optionally substituted glycolaldehyde dimer;
t is 0 or a positive integer representing the number of T repeating units;
L₁, L₂, L₃ and L₄ are, independently, divalent linkers selected from a single bond, —O—, —CO—, —O—CO—, —CO—O—, —NH—, —NR₁₀—, —S—, —SO—, —SO₂—, —PR₁₀—, —PO—(OR₁₀)—, —O—PO(OR₁₀)—O—, and a linear or branched divalent organic radical, where R₁₀ is a monovalent organic radical;
p is a positive integer representing the number of indicated repeating units; and each R_{M}, independently, is selected from hydrogen, deuterium, a hydroxyl group, an acyl group, an acyloxy group, an amino group, an alkylamino group, a (bisalkylamino) group, an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an aryl group, an aryloxy group, an alkoxyaryl group, an alkylaryl group, an alkyl carbonate group, an acrylate group, a methacrylate group, a group comprising an oxirane ring, a glycidyl group, a thiol group, an alkylthio group, a —COR₉ group, a —COOR₉ group, a —CON(R₉)₂ group, a —CSR₉ group, a —CS—OR₉ group, a —CO—O—CO—R₉ group, a —CO—NR₉—CO—R₉ group, a —N═C(R₉)₂, and a —CR₉═NR₉; where each R₉ is independently, a hydrogen, deuterium, alkyl, aryl, alkenyl or an alkynyl group, and each of R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group. In embodiments of the second aspect, each R_{M} is independently hydrogen, hydroxyl, linear or branched alkyl, methyl, ethyl, propyl, butyl, alkoxy, methoxy, ethoxy, propyloxy, acyl, acyloxy, acetyl, acetoxy, amino, alkylamino, aryl, alkylaryl, an acrylate group, or a methacrylate. In embodiments of the second aspect, L₁-L₄ independently is a single bond, —O—CO— or —CO—O—. embodiments of the second aspect, T is:

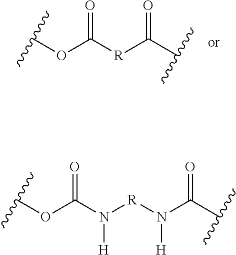

where —R— is divalent (bivalent) and is selected from a single bond, —O—, —NH—, —NR₁₀—, —S—, —SO—, —SO—, —PR₁₀—, —O—PO(OR₁₀)—O—, and an optionally substituted linear or branched divalent organic radical, where R₁₀ is a monovalent organic radical. In embodiments, R₁₀ is alkyl or aryl.

In embodiments of the second aspect, the ratio of t/d ranges from 0.01 to 100. In embodiments of the second aspect D is -DHDO- or -MDHDO-.

In embodiments of the second aspect, the polymer or copolymer has structure:

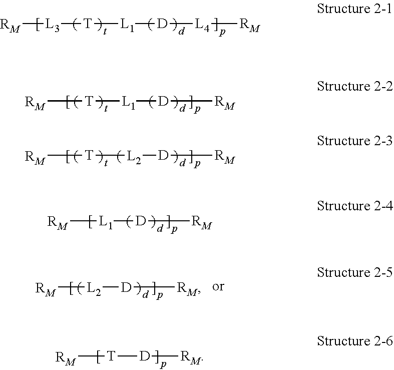

In embodiments of any preceding embodiment of the second aspect, T is

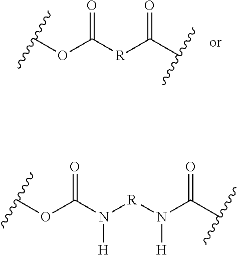

where —R— is divalent (bivalent) and is selected from a single bond, —O—, —NH—, —NR₁₀—, —S—, —SO—, —SO—, —PR₁₀—, —O—PO(OR₁₀)—O—, and an optionally substituted linear or branched divalent organic radical, where R₁₀ is a monovalent organic radical.

In embodiments of any preceding embodiment of the second aspect, the ratio of t/d ranges from 0.01 to 100. In embodiments of any preceding embodiment of the second aspect, D is -DHDO- or -MDHDO-.

In embodiments of any preceding embodiment of the second aspect, —R— is divalent and is selected from a single bond, —O—, —NH—, —NR₁₀—, —S—, —SO—, —SO₂, —PR₁₀—, —O—PO(OR₁₀)—O—, and an optionally substituted linear or branched divalent organic radical, where R₁₀ is a monovalent organic radical.

In embodiments of the second aspect, the polymer of copolymer has structure:

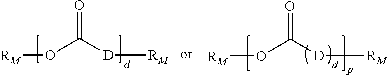

In further embodiments of any embodiments of the second aspect, D is -DHDO- or -MDHDO-.

In a third aspect the invention provides a method for making a copolymer of the first aspect, which comprises preparing a mixture of two or more glycolaldehyde dimers containing from 0.1% to 25% by weight of glycolaldehyde dimers other than 2,5-dihydroxy-1,4-dioxane; and polymerizing the mixture in the presence of a Lewis acid catalyst. In a further embodiment of the third aspect, the mixture is prepared to have 1% to 25% by weight of glycolaldehyde dimers other than 2,5-dihydroxy-1,4-dioxane. In a further embodiment, the mixture is prepared to have 1% to 10% by weight of glycolaldehyde dimers other than 2,5-dihydroxy-1,4-dioxane.

Groups herein are optionally substituted most generally with one or more alky, alkenyl, alkynyl, and aryl, heteroaryl, carbocyclyl, and heterocyclyl groups can be substituted, for example, with one or more oxo group, thioxo group, halogen, nitro, cyano, cyanate, azido, thiocyano, isocyano, isothiocyano, sulfhydryl, hydroxyl, alkyl, alkoxy, alkenyl, alkenyloxy, alkynyl, alkynyloxy, aryl, aryloxy, heteroaryl, heteroaryloxy, carbocyclyl, carbocyclyloxy, heterocyclyl, heterocyclyloxy, alkylthio, alkenylthio, alkynylthio, arylthio, thioheteroaryl, thioheteroaryl, thiocarbocyclyl, thioheterocyclyl, —CORs, —COH, —OCORs, —OCOH, —CO—ORs, —CO—OH, —CO—O—CO-Rs, —CON(Rs)2, —CONHRs, —CONH2, —NRs-CORs, —NHCORs, —NHRs, —N(Rs)2, —O—SO2-Rs, —SO2-Rs, —SO2-NHRs, —SO2-N(Rs)2, —NRs-SO2-Rs, —NH—SO2-Rs, —NRsCO—N(Rs)2, —NH—CO—NHRs, —O—PO(ORs)2, —O—PO(ORs)(N(Rs)2), —O—PO(N(Rs)2)2, —N—PO(ORs)2, —N—PO(ORs)(N(Rs)2), —P(Rs)2, —B(OH)2, —B(OH)(ORs), —B(ORs)2, where each Rs independently is an organic group and more specifically is an alkyl, alkenyl, alkynyl, aryl, heteroaryl, carbocyclyl, or heterocyclyl group or two Rs within the same substituent can together form a carbocyclic or heterocyclic ring having 3 to 10 ring atoms. Organic groups of non-hydrogen substituents are in turn optionally substituted with one or more halogens, nitro, cyano, isocyano, isothiocyano, hydroxyl, sulfhydryl, haloalkyl, hydroxyalkyl, amino, alkylamino, dialkylamino, arylalkyl, unsubstituted alkyl, unsubstituted alkenyl, unsubstituted alkynyl alkylalkenyl, alkylalkynyl, haloaryl, hydroxylaryl, alkylaryl, unsubstituted aryl, unsubstituted carbocylic, halo-substituted carbocyclic, hydroxyl-substituted carbocyclic, alkyl-substituted carbocyclic, unsubstituted heterocyclic, unsubstituted heteroaryl, alkyl-substituted heteroaryl, or alkyl-substituted heterocyclic. In specific embodiments, Rs groups of substituents are independently selected from alkyl groups, haloalkyl groups, phenyl groups, benzyl groups and halo-substituted phenyl and benzyl groups. In specific embodiments, non-hydrogen substituents have 1-20 carbon atoms, 1-10 carbon atoms, 1-7 carbon atoms, 1-5 carbon atoms or 1-3 carbon atoms. In specific embodiments, non-hydrogen substituents have 1-10 heteroatoms, 1-6 heteroatoms, 1-4 heteroatoms, or 1, 2, or 3 heteroatoms. Heteroatoms include O, N, S, P, B and Se and preferably are O, N or S.

In embodiments, optional substitution is substitution with one or more of the groups listed in the definitions of R₁-R₃ of Structure 1.

In specific embodiments, optional substitution is substitution with 1-12 (or 1-3 or 1 to 3 or 1 to 6) non-hydrogen substituents. In specific embodiments, optional substitution is substitution with 1-6 non-hydrogen substituents. In specific embodiments, optional substitution is substitution with 1-3 non-hydrogen substituents. In specific embodiments, optional substituents contain 6 or fewer carbon atoms. In specific embodiments, optional substitution is substitution by one or more halogen, hydroxyl group, cyano group, oxo group, thioxo group, unsubstituted C1-C6 alkyl group or unsubstituted aryl group. The term oxo group and thioxo group refer to substitution of a carbon atom with a ═O or a ═S to form respectively —CO-(carbonyl) or —CS— (thiocarbonyl) groups.

In specific embodiments, non-hydrogen substituents for optional substitution include alkyl, alkoxy, halogen (F, Cl, Br or I and preferably Cl or F), haloalkyl, or haloalkoxy. In specific embodiments, non-hydrogen substituents for optional substitution include methyl, ethyl, methoxy, ethoxy, F, Cl, and trifluoromethyl.

In embodiments herein, the polymers and copolymers of the invention do not include any halogen functionalization. In embodiments herein, the polymers and copolymers do not include any chloride functionalization. In embodiments herein, the polymers and copolymers do not include any flourine functionalization.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RsCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

As to any of the above groups which contain one or more substituents, it is understood that such groups do not contain any substitution or substitution patterns which are sterically impractical and/or synthetically non-feasible. In addition, the compounds of this invention include all stereochemical isomers arising from the substitution of these compounds.

Polymers and copolymers of the invention may contain chemical groups (acidic or basic groups) that can be in the form of salts. Exemplary acid addition salts include acetates (such as those formed with acetic acid or trihaloacetic acid, for example, trifluoroacetic acid), adipates, alginates, ascorbates, aspartates, benzoates, benzenesulfonates, bisulfates, borates, butyrates, citrates, camphorates, camphorsulfonates, cyclopentanepropionates, digluconates, dodecylsulfates, ethanesulfonates, fumarates, glucoheptanoates, glycerophosphates, hemisulfates, heptanoates, hexanoates, hydrochlorides (formed with hydrochloric acid), hydrobromides (formed with hydrogen bromide), hydroiodides, 2-hydroxyethanesulfonates, lactates, maleates (formed with maleic acid), methanesulfonates (formed with methanesulfonic acid), 2-naphthalenesulfonates, nicotinates, nitrates, oxalates, pectinates, persulfates, 3-phenylpropionates, phosphates, picrates, pivalates, propionates, salicylates, succinates, sulfates (such as those formed with sulfuric acid), sulfonates (such as those mentioned herein), tartrates, thiocyanates, toluenesulfonates such as tosylates, undecanoates, and the like.

Exemplary basic salts include ammonium salts, alkali metal salts such as sodium, lithium, and potassium salts, alkaline earth metal salts such as calcium and magnesium salts, salts with organic bases (for example, organic amines) such as benzathines, dicyclohexylamines, hydrabamines [formed with N,N-bis(dehydro-abietyl)ethylenediamine], N-methyl-D-glucamines, N-methyl-D-glucamides, t-butyl amines, and salts with amino acids such as arginine, lysine and the like. Basic nitrogen-containing groups may be quaternized with agents such as lower alkyl halides (e.g., methyl, ethyl, propyl, and butyl chlorides, bromides and iodides), dialkyl sulfates (e.g., dimethyl, diethyl, dibutyl, and diamyl sulfates), long chain halides (e.g., decyl, lauryl, myristyl and stearyl chlorides, bromides and iodides), aralkyl halides (e.g., benzyl and phenethyl bromides), and others.

Compounds of the present invention, and salts thereof, may exist in their tautomeric form, in which hydrogen atoms are transposed to other parts of the molecules and the chemical bonds between the atoms of the molecules are consequently rearranged. It should be understood that all tautomeric forms, insofar as they may exist, are included within the invention.

Additionally, inventive compounds may have trans and cis isomers and may contain one or more chiral centers, therefore exist in enantiomeric and diastereomeric forms. The invention includes all such isomers, as well as mixtures of cis and trans isomers, mixtures of diastereomers and racemic mixtures of enantiomers (optical isomers). When no specific mention is made of the configuration (cis, trans or R or S) of a compound (or of an asymmetric carbon), then any one of the isomers or a mixture of more than one isomer is intended. The processes for preparation can use racemates, enantiomers, or diastereomers as starting materials. When enantiomeric or diastereomeric products are prepared, they can be separated by conventional methods, for example, by chromatographic or fractional crystallization. The inventive compounds may be in the free or hydrate form. With respect to the various compounds of the invention, the atoms therein may have various isotopic forms, e.g., isotopes of hydrogen include deuterium and tritium. All isotopic variants of compounds of the invention are included within the invention and particularly included at deuterium and 13C isotopic variants. It will be appreciated that such isotopic variants may be useful for carrying out various chemical and biological analyses, investigations of reaction mechanisms and the like. Methods for making isotopic variants are known in the art.

In polymer and copolymer structures herein, specific bonds (for example, —O— bonds through oxygen) may not be explicitly shown in the structure. One of ordinary skill in the art recognizes that polymerization of monomers or addition of monomers to the ends of polymers as disclosed herein requires the formation of bonds between monomers and or polymers and in particular the formation of bonds containing an oxygen and they will appreciate the presence in the structures illustrated as needed. In many polymers and copolymers herein bonds between monomers are formed by reaction of two —OH groups to form a —O— bond with release for example of H₂O. If such bonds are not explicitly shown in the structures herein, one of ordinary skill in the art would recognize that the appropriate bonds must be present between two monomers, a monomer and a polymer, two polymers or between the end groups of polymers and any R_{M} or R₃ group.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although this invention has been specifically disclosed by preferred embodiments, exemplary embodiments and optional features, modification and variation of the concepts disclosed may be resorted to by those skilled in the art, and that such modifications and variations are considered to be within the scope of this invention as defined by the claims. The specific embodiments provided are examples of useful embodiments of the invention and it will be apparent to one skilled in the art that the invention may be carried out using a large number of variations of the devices, device components, methods steps set forth in the description.

As used in this specification and in the appended claims, the singular forms “a”, “an”, and “the” include plural references unless the context clearly dictates otherwise. Also, the terms “a” (or “an”), “one or more” and “at least one” can be used interchangeably. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

All references throughout this application, for example patent documents including issued or granted patents or equivalents; patent application publications; and non-patent literature documents or other source material; are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all possible combinations and subcombinations of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination.

One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, or limitation or limitations which is/are not specifically disclosed herein.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

### THE EXAMPLES

### Example 1: Synthesis of Polyacetals

A. A polymer of Structure 1 with n/(n+m+l+g+h+i+k+j)<0.95 and (m+l+g+h+i+k+j)/(n+m+l+g+h+i+k+j)>0.05 and R₁, R₂, R₃=H.

A raw material blend of glyaldehyde dimer comprising >90% by wt of 2,5-dihydroxy-1,4-dioxane and the reminder <10% wt. being a mixture of 2-(hydroxymethyl)-1,3-dioxolan-4-ol, 1,1′-oxydi(ethane-1,2-diol) and 1,2-dihydroxyethoxyacetaldehyde is obtained from a commercial source. This raw material is a sticky waxy semi-clear material.

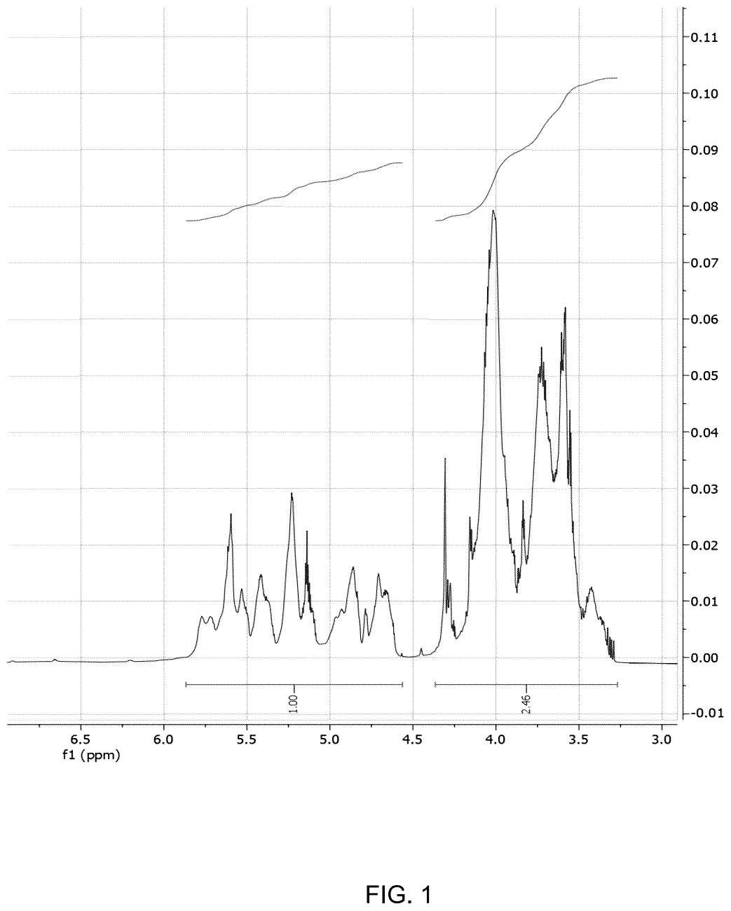

This raw material (1 g) is dissolved in 70 mL of anhydrous acetonitrile in oven-dried glassware and 0.2 g of scandium triflate is added. The reaction is refluxed in the presence of freshly activated molecular sieves 3A at 45° C. under reduced pressure (105 Torr) overnight. The solvent is evaporated at the end of the reaction and the crude product is washed with water, and dried under vacuum. ¹H NMR spectrum of the product (FIG. 1) showed signal typical of six-member cycles, five-member cycles and linear repeat units. Specifically, the large peak of 4.0 ppm indicates the presence of a significant fraction of linear repeat units. This material is an example of a copolymer formed from a mixture of glycolaldehyde dimers PMDHDO. This polymer is cast on a Teflon® (Trademark, The Chemours Company) fluoropolymer mold into a thin film from an acetone solution. The film is clear and can be easily removed from the Teflon® fluoropolymer block without cracking. The film shows good flexibility when bent over a glass rod.

B. Comparative Example: a polymer of Structure 1 with n/(n+m+l++g+h+i+k+j)>0.95 and (m+l+g+h+i+k+j)/(n+m+l+g+h+i+k+j)<0.05 and R₁, R₂, R₃=H.

A sample of 2,5-dihydroxy-1,4-dioxane with purity of >99.5% is obtained from commercial sources. This raw material is a white crystalline powder.

This raw material (1 g) is dissolved in 70 mL of anhydrous acetonitrile in oven-dried glassware and 0.2 g of scandium triflate is added. The reaction is refluxed in the presence of freshly activated molecular sieves 3A at 40° C. and the pressure is progressively reduced over a three day period until the solvent is completely removed. The crude product is washed with water, and dried under vacuum.

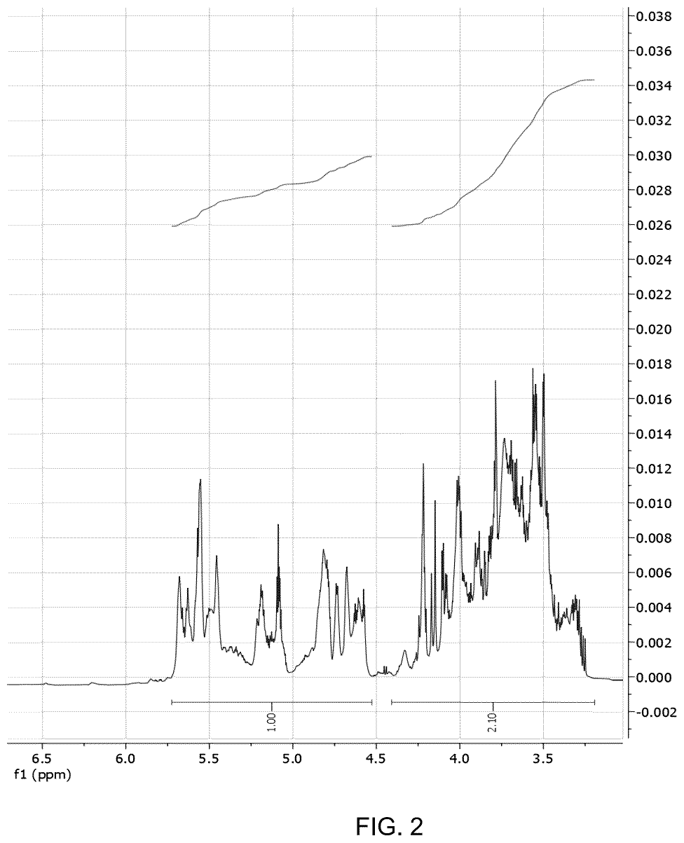

The ¹H NMR spectrum of the product (FIG. 2) shows the predominant proton signals typical of six-member cycles units. Specifically, the axial CH are at 5.00-5.60 ppm, the equatorial CH are at 4.5-5.0 ppm and the six-member ring CH₂ are at 3.2-4.2 ppm. This polymer is an example of PDHDO which does not contain any significant level of glycolaldehyde dimers other than the six-member ring repeat unit Q in Structure 1. This polymer is cast on a Teflon® fluoropolymer mold into a thin film from an acetone solution. The film is hazy upon drying and it is difficult to remove from the Teflon® fluoropolymer block without cracking. It cannot be bent over a glass rod without cracking.

C. 2,5-Dihydroxy-1,4-dioxane with 95% purity (4 g, 33 mmoles) is dissolved in 70 mL of anhydrous acetonitrile in oven-dried glassware and 0.244 g of lanthanum triflate is added. The reaction is refluxed in the presence of freshly activated molecular sieves 3A at 45° C. under reduced pressure (105 Torr) for 48 hrs. The solvent is evaporated at the end of the reaction and the crude product is washed with water, and dried under vacuum. The purity of reactant 2,5-dihydroxy-1,4-dioxane can be selected to prepare the desired copolymers of Structure 1.

D. 2,5-Dihydroxy-1,4-dioxane with purity of >99.5% (1 g) is dissolved in 20 mL of moist acetonitrile (10% by volume minimum water content) and stirred for several hours. 50 mL of the ionic liquid1-Butyl-3-methylimidazolium trifluoromethanesulfonate is then added and the acetonitrile and water are removed by fractional distillation. After the removal of water and acetonitrile has been completed, 0.08 g of lanthanum triflate is added to the ionic liquid solution of the monomer and the reaction is placed under high vacuum for 12 hours at 30° C. The next day, excess hexane is added to precipitate the prepared polymer, which is rinsed and dried. ¹H-NMR analysis shows that the prepared polymer contains repeat units that are both linear and cyclic dimers of glycolaldehyde, an example of PMDHDO.

E. A polymer of Structure 1 with n/(n+m+l+g+h+i+k+j)<0.95 and (m+l+g+h+i+k+j)/(n+m+l+g+h+i+k+j)>0.05, R₁, R₂=H and R₃=COCH₃.

The product of example 1A (1 eq) is end-capped by reaction with acetic anhydride (2.2 eq) in chloroform in the presence of 0.1 molar % of 4-dimethylaminepyridine. After stirring the reaction for 4 hours, the solvent is evaporated under vacuum. The crude product is dissolved in CHCl₃, washed with a 5% aqueous solution of sodium bicarbonate and then washed with water, dried over MgSO4, and evaporated under reduced pressure to produce a solid.

F. A copolymer of Structure 1 with n/(n+m+l+g+h+i+k+j)<0.95 and (m+l+g+h+i+k+j)/(n+m+l+g+h+i+k+j)>0.05, R₁=H, R₂=H and CH₃, and R₃=H. is prepared my mixing 1 g of 2,5-dihydoxy-1,4-dioxane with purity of >99.5% with 0.7 g of lactaldehyde dimer in 50 mL of anhydrous acetonitrile. 0.15 g scandium triflate is added and the reaction is set to reflux at 40° C. at reduced pressure of 110 Torr and in the presence of freshly activated molecular sieves for three days. After polymerization begins, the solvent is gradually removed and the reaction is allowed to continue. After 72 hours the reaction is stopped by rinsing the solid with water and drying under vacuum.

### Example 2: Synthesis of Polyesters

A. A polyester copolymer of Structure 3-2, with t=1 and d=1 and R=—CH₂CH₂— is prepared by reaction of 2,5-dihydroxy-1,4-dioxane with succinyl dichloride. 2,5-Dihydroxy-1,4-dioxane (DOHD, 1.2 g, 100 mmoles) with purity of >99.5% is dissolved in a dicholoromethane/acetonitrile mixture. Triethylamine (2.2 g, 220 mmoles) is added and the mixture is cooled in an ice bath. Succinic acid dichloride (1.55 g, 100 mmoles) is added dropwise. The reaction is allowed to warm up to room temperature and then brought to gentle reflux for 1 hr. A white precipitate forms, which is decanted off and then rinsed with a 5% sodium bicarbonate solution until pH>8 is obtained. The product is then filtered off and dried. A small portion is dissolved in deuterated chloroform and the structure is confirmed by ¹H-NMR analysis.

B. A polyester copolymer of Structure 3-2 with t=1 and d=1 and R=—CH₂CH₂— is prepared by reaction of 2,5-dihydroxy-1,4-dioxane with dimethyl succinate. 2,5-Dihydroxy-1,4-dioxane (12 g, 1 eq.) with purity of >99.5%, is dissolved in propionitrile (50 mL) and 25 mL of boron trifluoride acetonitrile complex solution (Sigma Aldrich) is added. Dimethyl succinate (1 eq.) is added and the mixture is set to gentle reflux overnight. The methanol byproduct is condensed in a Dean Stark trap. The mixture is allowed to cool and the solvent is removed using a rotary evaporator. After solvent evaporation, a white precipitate formed. The solid product is then filtered off, rinsed and dried.

C. A polyester copolymer of Structure 4-1 with p=1, q=1 and R=—CH₂CH₂— is prepared by reaction of a mixture of various glycolaldehyde dimers with succinyl dichloride. A mixture (1.2 g, 100 mmoles) containing 95 wt % of 2,5-dihydroxy-1,4-dioxane and the reminder 5 wt % being a mixture of other glycolaldehyde dimers: (1,2-dihydroxyethoxy)acetaldehyde; 2-(hydroxymethyl)-1,3-dioxolan-4-ol; 1,1′-oxydi(ethane-1,2-diol); 1,2-dihydroxyethoxyacetaldehyde; (1,3-dioxetane-2,4-diyl)dimethanol; and 2,2′-oxydiacetaldehyde) is dissolved in a dicholoromethane/acetonitrile mixture. Triethylamine (2.2 g, 220 mmoles) is added and the mixture is cooled in an ice bath. Succinic acid dichloride (1.55 g, 100 mmoles) is added dropwise. The reaction is allowed to warm up to room temperature and then brought to gentle reflux for 1 hr. A white precipitated forms, which is rinsed with a 5 wt % sodium bicarbonate solution until pH>8 is obtained. The polymer product is then filtered off and dried.

D. A polyester copolymer of Structure 3-2 with t=1 and d>1 and R=—CH₂CH₂— is prepared by reaction of the polymer product PDHDO of Example 1B with succinic acid dichloride. The PDHDO prepolymer is prepared as described in Example 1B. 1.20 gr of PDHDO is dissolved in chloroform, 0.13 gr of triethylamine is added and the mixture is cooled in an ice bath. Succinic acid dichloride (0.01 g) is added dropwise. The reaction is allowed to warm up to room temperature and then brought to gentle reflux for 1 hr. The crude reaction is cooled to room temperature, washed with sodium bicarbonate until pH=8. The organic phase is separated and the solvent evaporated at the rotary evaporator. A powdery material is obtained. This material is too brittle to be cast into thin films.

E. A polyester copolymer of Structure 4-1 with q=1 and p>1, R₁ and R₂=H, and R=—CH₂CH₂— is prepared by reaction of the polymer product containing two or more glycolaldehyde dimers as monomers (PMDHDO) of Example 1A with succinic acid dichloride. The polyacetal prepolymer (PMDHDO) is prepared as described in Example 1A. 1.20 gr of this prepolymer is dissolved in chloroform, 0.13 gr of triethylamine is added and the mixture is cooled in an ice bath. Succinic acid dichloride (0.01 g) is added dropwise. The reaction is allowed to warm up to room temperature and then brought to gentle reflux for 1 hr. The crude reaction is cooled to room temperature, washed with sodium bicarbonate until pH=8. The organic phase is separated and the solvent evaporated at the rotary evaporator. An amorphous semi-clear material is obtained. This material is cast into thin films from a chloroform solution.

F. A polyester copolymer of Structure 3-2 with t=1 and d=1 and R=phenylene is prepared by reaction of 2,5-dihydroxy-1,4-dioxane with dimethyl terephthalate. 2,5-dihydroxy-1,4-dioxane (12 g, 1 eq.) with purity of >99.5% is dissolved in propionitrile (50 mL) and 25 mL of boron trifluoride acetonitrile complex solution (Sigma Aldrich) is added. Dimethyl terephthalate (1 eq.) is added and the mixture is set to gentle reflux overnight. The methanol byproduct is condensed in a Dean Stark trap. The reaction mixture is allowed to cool and the solvent removed using a rotary evaporator. After solvent evaporation, a white precipitate formed. The solid product is then filtered off, rinsed and dried.

G. A polyester copolymer of Structure 3-2 with t=1 and d=1 and R=2,5-furanylene (divalent furane) is prepared by reaction of 2,5-dihydroxy-1,4-dioxane with 2,5-furandicarbonyl dichloride. 2,5-Dihydroxy-1,4-dioxane (DOHD, 1.2 g, 100 mmoles) with purity of >99.5% is dissolved in a dicholoromethane/acetonitrile mixture. Triethylamine (2.2 g, 220 mmoles) is added and the mixture is cooled in an ice bath. 2,5-furandicarbonyl dichloride (100 mmoles) is added dropwise. The reaction is allowed to warm up to room temperature and then brought to gentle reflux for 1 hr. A white precipitate forms, which is decanted off and then rinsed with a 5% sodium bicarbonate solution until pH>8 is obtained. The product is then filtered off and dried. A small portion is dissolved in deuterated chloroform and the structure is confirmed by ¹H-NMR analysis.

### Example 3: Synthesis of Polyurethanes

A. A polyurethane copolymer of Structure 3-3 with t=1 and d=1 and R=—(CH₂)₆— is prepared by reaction of DHDO with hexamethylene diisocyanate. DHDO (0.1 mol) with nominal purity of 100% is dissolved in minimal amount of acetonitrile and 0.5% by mole of dibutyltin dilaurate and 0.5% of 1,8-diazabicyclo[5.4.0]undecen-7-ene were added. 0.1 mol of hexamethylene diisocyanate is added under vigorous stirring to form a fibrous material after solvent evaporation.

B. A polyurethane copolymer of Structure 4-2 with d=1 and t>1 and R=—(CH₂)₆— is prepared by reaction of the product of example 1A (PMDHDO) with hexamethylene diisocyanate 1.20 gr of the polymer prepared in example 1A is dissolved in acetone, 0.13 gr of hexamethylene diisocyanate is added dropwise followed by a catalytic amount of dibutyl tin dilaurate and triethylamine, and the reaction is allowed to stir for a few hours at 60 C. The crude reaction is cooled to room temperature, washed and the solvent evaporated at the rotary evaporator. An amorphous semi-clear material is obtained. This material is cast into thin films from a chloroform solution.

C. A polyurethane copolymer of Structure 3-2 with t=1 and d>1 and R=—(CH₂)₆— is prepared by reaction of the product of example 1B (PDHDO) with hexamethylene diisocyanate 1.20 gr of the polymer prepared in example 1B is dissolved in acetone, 0.13 gr of hexamethylene diisocyanate is added dropwise followed by a catalytic amount of dibutyl tin dilaurate and triethylamine, and the reaction is allowed to stir for a few hours at 60 C. The crude reaction is cooled to room temperature, washed and the solvent evaporated at the rotary evaporator. An amorphous semi-clear material was obtained. This material was cast into thin films from a chloroform solution.

D. A polyurethane foam was prepared following the general recipe described in J. Chem. Educ. 2010, 87, 2, 212-215, which is incorporated by reference herein for the description of the recipe. A polyol mixture is prepared by mixing with a high shear mixer 5 g of PDHDO prepolymer prepared using example 1B, with 15 g of a 3000MW glycerin and propylene oxide based polyether polyol triol (Carpol GP-3000). Once the mixture is homogeneous 0.6 g of deionized water, 0.2 g of dibutyltin dilaurate (DBTL), and 0.4 g of silicone surfactant (Dow Corning, 193 Surfactant) are added. The components are mixed vigorously for 1 min with a mechanical stirrer in a 500 mL beaker. Then 11.5 g of diphenylmethane 4,4-diisocyanate (MDI) was added to the same beaker and rigorously stirred for 15 s. The resulting mixture is left to rest and react for a few minutes, which allows the formation of the foam.

E. A polyurethane foam is prepared following the general recipe described in J. Chem. Educ. 2010, 87, 2, 212-215. A polyol mixture is prepared by mixing with a high shear mixer 15 g of a polyacetal prepolymer PMDHDO prepared using example 1A, with 5 g of a 1000 Mw glycerin and propylene oxide based polyether polyol triol (Carpol GP-1000). Once the mixture is homogeneous 0.6 g of deionized water, 0.2 g of dibutyltin dilaurate (DBTL), and 0.4 g of silicone surfactant (Dow Corning, 193 Surfactant) are added. The components are mixed vigorously for 1 min with a mechanical stirrer in a 500 mL beaker. Then 13.5 g of diphenylmethane 4,4-diisocyanate (MDI) was added to the same beaker and rigorously stirred for 15 s. The resulting mixture is left to rest and react for a few minutes, which allows the formation of the foam.

F. A polyurethane coating is prepared by mixing hexamethylene diisocyanate trimer (HDI trimer, Desmur-N) with the polyacetal pre-polymer prepared in Example 1A (PMDHDO). The polyacetal prepolymer is first degassed under vacuum and then mixed with the catalyst dibutyl tin dilaurate with a mechanical stirrer at 35° C. The HDI trimer is then added and the mixture stirred until homogeneous. The mixture is then sprayed on a steel plate and allowed to cure at 50° C. for 12 h to give a though coating of homogeneous thickness.

### Example 4. Synthesis of Polycarbonates

A. A polymer of Structure 5-1. 2,5-Dihydroxy-1,4-dioxane (0.1 mole) purity of >99.5% is dissolved in a pyridine/THF mixture and 0.05% wt of 4-dimethylaminopyridine is added. Dimethyl carbonate (0.1 mol) is added and the mixture is brought to reflux under reduced pressure. Methanol is condensed in a Dean-Stark trap. After 4 hours, the crude reaction is cooled to room temperature, washed, and the solvent evaporated at the rotary evaporator. An amorphous powdery material is obtained.

B. A polymer of Structure 6-2. The polymer prepared in example 1A (PMDHDO, 1.2 g) is dissolved in dimethyl carbonate and 0.05% wt of 4-dimethylaminopyridine is added. The mixture is brought to reflux under reduced pressure. Methanol is condensed in a Dean-Stark trap. After 6 hours, the crude reaction is cooled to room temperature, washed, and the solvent evaporated at the rotary evaporator. An amorphous semi-clear material was obtained. This material was cast into thin films from a chloroform solution.

We claim:

1. A polymer that comprises two or more structurally different glycolaldehyde dimers as monomer units wherein the dimers are selected from the group consisting of 2,5-dihydroxy-1,4-dioxane; (1,2-dihydroxyethoxy)acetaldehyde; 2-(hydroxymethyl)-1,3-dioxolan-4-ol; 1,1′-oxydi (ethane-1,2-diol); 2,2′-oxydi(ethane-1,1-diol); (1,3-dioxetane-2,4-diyl)dimethanol; and 2,2′-oxydiacetaldehyde.

2. The polymer of claim 1 having from 0.1% to 25% by weight of glycolaldehyde dimers other than 2,5-dihydroxy-1,4-dioxane.

3. A polymer of claim 1 of Structure 1: 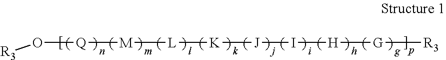
where: 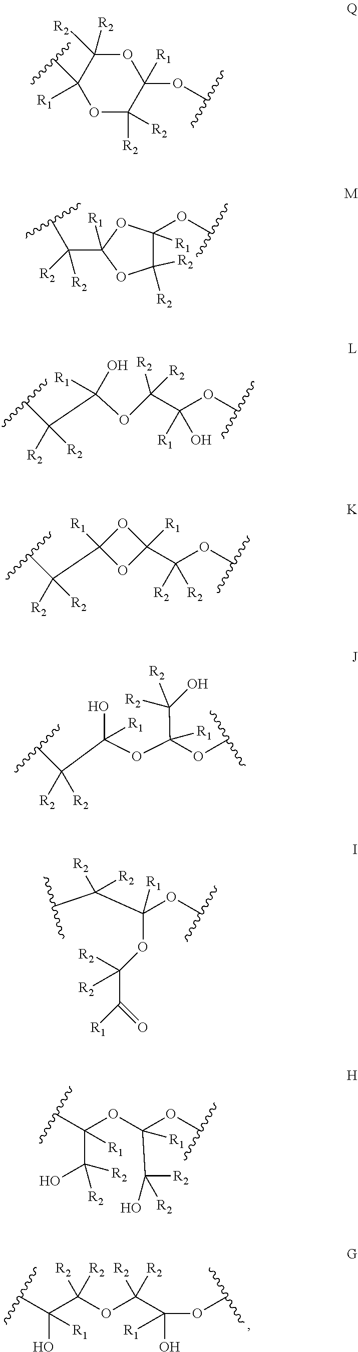
where Q, M, L, K, J, I, H and G are divalent glycolaldehyde dimer species as illustrated and g, h, i, j, k, l, m and n are integers from zero to 10 million, wherein at least two of g, h, i, j, k, l, m and n are different from zero and p is an integer ranging from 1-10 million; and
each R₁, R₂ and R₃ 4.is independently selected from the group consisting of hydrogen (—H), deuterium (-D), an halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C≡N), a isocyanate group (—N═C═O), a azide group (—N₃), a cyanate group (—O—C═N), a nitroso group (—NO), a phosphine group [—P(R₉)₂], a phosphate group [—OP(O)(OR₉)₂], a phosphonate group [—P(O)(OR₉)₂], a sulfate group (—O—SO₃R₉), a sulfonate group (—SO₃R₉), a thiocyanate group (—S═C═N), a iso thiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N═C(R₉)₂, and a —CR═NR₉; where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group; and/or
each R₁, R₂ and R₃ is independently optionally oligomeric, pre-polymeric or polymeric in nature and selected from the group consisting of end-capped or uncapped polyethers, poly(fluoroethers), polyglycols, polyacetals, polyolefins, polystyrene, polyfluoroolefins, polyoxides, polychlorolefins, polychlorofluoroolefins, polysiloxanes, polyesters, polybromoesters, natural and synthetic rubbers, polyols, polyalcohols, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitriles, polybutadiene, alkyds, polyurethanes, epoxies, cellulose and its derivatives, starch and its derivatives, polypeptides, and copolymers thereof.

4. The polymer of claim 3, wherein each R₁ and each R₂ are independently selected from hydrogen, deuterium, optionally substituted alkyl groups having 1-3 carbon atoms, optionally substituted aryl groups, and optionally substituted phenyl or benzyl groups.

5. The polymer of claim 3, wherein each R₃ independently is hydrogen, deuterium, alkyl, alkoxy, acyl, acrylate, methacrylate, aminoalkylene, (alkylamino)alkylene, (bisalkylamino)alkylene, or glycidyl.

6. The polymer of claim 5, wherein each R₁ and each R₂ are hydrogen.

7. The polymer of claim 3, wherein (n+m+l)×p ranges from 10 to 200,000.

8. The polymer of claim 3, wherein (n+m+l+k+j+i+h+g)×p ranges from 2 to 200,000.

9. A polymer or copolymer of Structure 2: 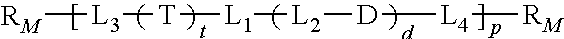
where:
D is a divalent organic radical formed on polymerization of an optionally substituted glycolaldehyde dimer;
d is a positive integer representing the number of D repeating units;
T is a divalent radical formed on polymerization of a second monomer which is other than an optionally substituted glycolaldehyde dimer;
t is 0 or a positive integer representing the number of T repeating units;
L₁, L₂, L₃ and L₄ are, independently, divalent linkers selected from a single bond, —O—, —CO—, —O—CO—, —CO—O—, —NH—, —NR₁₀—, —S—, —SO—, —SO₂—, —PR₁₀—, —PO—(OR₁₀)—, —O—PO(OR₁₀)—O—, and a linear or branched divalent organic radical, where R₁₀ is a monovalent organic radical;
p is a positive integer representing the number of indicated repeating units; and
each R_{M}, independently, is selected from hydrogen, deuterium, a hydroxyl group, an acyl group, an acyloxy group, an amino group, an alkylamino group, a (bisalkylamino) group, an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an aryl group, an aryloxy group, an alkoxyaryl group, an alkylaryl group, an alkyl carbonate group, an acrylate group, a methacrylate group, a group comprising an oxirane ring, a glycidyl group, a thiol group, an alkylthio group, a —COR₉ group, a —COOR₉ group, a —CON(R₉)₂ group, a —CSR₉ group, a —CS—OR₉ group, a —CO—O—CO—R₉ group, a —CO—NR₉—CO—R₉ group, a —N═C(R₉)₂, and a —CR₉═NR₉; where each R₉ is independently, a hydrogen, deuterium, alkyl, aryl, alkenyl or an alkynyl group, and each of R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group.

10. The polymer or copolymer of claim 9, wherein each R_{M} is independently hydrogen, hydroxyl, linear or branched alkyl, methyl, ethyl, propyl, butyl, alkoxy, methoxy, ethoxy, propyloxy, acyl, acyloxy, acetyl, acetoxy, amino, alkylamino, aryl, alkylaryl, an acrylate group, or a methacrylate.

11. The polymer or copolymer of claim 9, wherein L₁-LU independently is a single bond, —O—CO— or —CO—O—.

12. The polymer or copolymer of claim 9, wherein T is 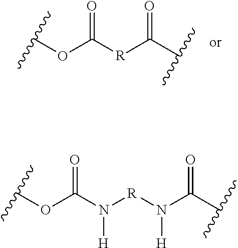
where —R— is divalent (bivalent) and is selected from a single bond, —O—, —NH—, —NR₁₀—, —S—, —SO—, —SO₂—, —PR₁₀—, —O—PO(OR₁₀)—O—, and an optionally substituted linear or branched divalent organic radical, where R₁₀ is a monovalent organic radical.

13. The polymer or copolymer of claim 9, wherein the ratio of t/d ranges from 0.01 to 100.

14. The polymer or copolymer of claim 9, wherein D is -DHDO- or -MDHDO-.

15. The polymer or copolymer of claim 9 of structure:

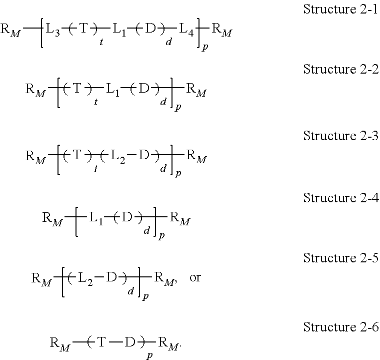

16. The polymer or copolymer of claim 15, wherein T is 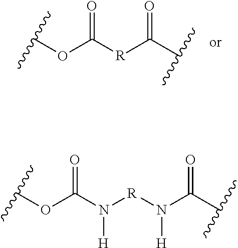
where —R— is divalent (bivalent) and is selected from a single bond, —O—, —NH—, —NR₁₀—, —S—, —SO—, —SO₂—, —PR₁₀—, —O—PO(OR₁₀)—O—, and an optionally substituted linear or branched divalent organic radical, where R₁₀ is a monovalent organic radical.

17. The polymer or copolymer of claim 15, wherein the ratio of t/d ranges from 0.01 to 100.

18. The polymer or copolymer of claim 15, wherein D is -DHDO- or -MDHDO-.

19. The polymer or copolymer of claim 9 of structure:

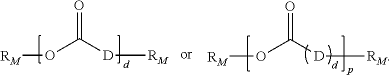

20. The polymer or copolymer of claim 19, wherein D is -DHDO- or -MDHDO-.

21. A method of making a copolymer of claim 1 which comprises:
preparing a mixture of two or more glycolaldehyde dimers containing from 0.1% to 25% by weight of glycolaldehyde dimers other than 2,5-dihydroxy-1,4-dioxane; and polymerizing the mixture in the presence of a Lewis acid catalyst.
